(19) United States
(12) Patent Application Publication
(10) Pub. No.: US 2009/0186767 A1
(43) Pub. Date: Jul. 23, 2009

(54) Use of surfactants for mitigating damage to plants from pests

(75) Inventors: Stephen Craig Arbogast, Port St. Lucia, FL (US); Herbert Nicholas Nigg, Lake Alfred, FL (US); Ronald A. Becton, Ft. Pierce, FL (US)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(73) Assignee: Cleareso, LLC

(21) Appl. No.: 12/218,166

(22) Filed: Jul. 11, 2008

Related U.S. Application Data
(60) Provisional application No. 61/022,307, filed on Jan. 18, 2008.

(51) Int. Cl. A01N 37/02; A01P 13/00; A01P 5/00; A01P 7/04

(52) U.S. Cl. 504/313; 514/552

(57) ABSTRACT

A method is described for treating soil to increase plant growth or improve the health of plants, wherein an aqueous solution of polyethoxylated fatty acids and/or fatty alcohols is used which has pesticidal effects. In some embodiments, the method can be used against soil pests such as at least one of nematodes, soil-dwelling insects, and weeds. The invention also pertains to methods for applying bio-derived surfactants to crops and other plants or to the soil used for such plants in order to reduce the need to apply environmentally unfriendly pesticides substances.

This application claims the benefit of U.S. provisional patent application Ser. No. 61/022,307, filed Jan. 18, 2008, for Use of Surfactants for Mitigating Damage to Plants from Pests.

### BACKGROUND

1. Field of the Invention

This invention pertains to methods and compositions for treating soil or plants to mitigate the harmful effects of pests. The invention also pertains to methods for applying bio-derived materials to crops and other plants or to the soil used for such plants in order to reduce the need for the application of environmentally unfriendly pesticides.

2. Description of the Related Art

Without the use of pesticides and other means for treating agricultural pests, crop yields would be drastically lower, resulting in extreme shortages of many agricultural products. Even with modern pesticides, substantial crop losses occur due to a wide variety of pests. Agricultural pests such as arthropods (particularly insects), nematodes, weeds, and disease pathogens (viruses, bacteria, fungi, etc.) blemish, damage or destroy more than 30 percent of crops worldwide. Plant parasitic nematodes cause serious extensive damage to many agricultural crops. These generally microscopic worms feed mostly on the roots of host plants, but some species attack other parts such as stems, leaves and flowers. Almost all of the major plant species are susceptible to infection by species of nematodes. Arthropods such as root weevils and many other insects also cause extensive damage to agricultural plants. Weeds result in further harm, being responsible for reductions of about 12 percent in crop yields and 20 percent in forage yields.

In the past, methyl bromide was seen as an attractive tool for dealing with many of the soil pests farmers faced. Pre-plant treatment of soil with methyl bromide was found to be effective against most nematodes, many weeds, insect larvae, and other soil parasites. While there were obvious economic benefits of methyl bromide, it has now been banned, or is being phased out of use because of its potential threat to the environment. While large sums of money have been spent in the search for environmentally friendly replacements for methyl bromide, no proposed replacement has been adequate. Many other toxic agents have been proposed, or used, that are believed to be less harmful to the environment. However, there remains an unmet need to find safe, environmentally responsible alternatives that can provide some, or all, of the benefits provided by the treatment of soil with methyl bromide, as well as providing other agricultural or horticultural benefits without harming the environment.

In addition to methyl bromide treatment of the soil, many other toxic compounds are routinely used to treat pests above ground, and there remains a need to find alternatives that can be effective against undesirable pests. In several applications, there is a need for compounds that are relatively safe, biodegradable, and/or derived from natural compounds to replace some of the harmful agents currently in use.

Surfactants represent a broad class of compounds that have been explored as tools to assist in the control of pests. A variety of surfactants, including detergents, have been used as adjuvants in pesticidal formulations, often assisting in the application of the active ingredient. Insecticidal soaps have also been proposed for killing or repelling a variety of plant pests such as aphids, mites, and earwigs.

Surfactants per se are known not to be necessarily harmful to nematodes. Indeed, insecticidal soaps and other surfactants have been used in combination with applied nematodes as a means of controlling pests that may be attacked by the nematodes, indicating compatibility or even synergy between the two treatments. For example, H. K. Kaya et al., “Integration of Entomopathogenic Nematodes with Bacillus thuringiensis or Pesticidal Soap for Control of Insect Pests,” Biological Control, 5: 432-441 (1995) reports that nematodes could be applied successfully with pesticidal soaps in the treatment of some pests. Surfactants can be harmful, though, so the authors warn that storing the nematodes in the pesticidal soap solution for over 24 hours is discouraged. Likewise, M. Mutwakil et al., “Surfactant Stimulation of Growth in the Nematode Caenorhabditis elegans,” Enzyme and Microbial Technology, Vol. 20, 1997, pp. 462-470, report that a variety of surfactants at 10 ppm concentration stimulated growth of nematode larvae. Others have reported certain surfactant and nematode combinations have been more harmful to the nematodes.

In one study by Pinkerton and Kitner, “Effects of Biologically-Derived Products on Mobility and Reproduction of the Root-Lesion Nematode, Pratylenchus Penetrans, on Strawberry,” Nematropica, Vol. 36, No. 2, 2006, pp. 181-196, a mixture of sodium lauryl sulfate and citric acid immobilized some of the nematodes, though mobility was restored by subsequent incubation in water. In greenhouse tests, this mixture reduced nematode growth significantly if applied at planting, but stunted plant growth. Though several biologically-derived products were explored, none was as effective as the conventional nematicide, fenamiphos.

Some fatty acids and fatty acid derivatives have been identified as toxic to certain undesirable nematodes and to some other pests. This work has generally pointed to surfactants with short carbon chains (e.g., 9 carbons or 9 to 14 carbons). For example, U.S. Pat. No. 6,124,359, “Materials and Methods for Killing Nematodes and Nematode Eggs,” issued Sep. 26, 2000, discusses compositions and processes for controlling nematodes through the use of certain fatty acid compounds (including fatty acid esters) from about C8 to about C14 that can be in the epoxide, cyclopropane, methylated, or hydroxylated forms.

T. C. Vrain, “Fatty Acids and Their Derivatives for Nematode Control,” Journal of Nematology, Vol. 12, No. 4, October 1980, p. 240, reports that “butyric acid and other short chain saturated fatty acids were shown to be nematicidal.” Twelve fatty acids (C3 to C18) and some of their derivatives (seven potassium salts, seven methyl esters, and four primary alcohols) were investigated in vitro with a few additional greenhouse tests. Toxicity increased with carbon number for C3 through C11, then became inversely related with carbon number for the higher numbers. Oleic acid (C18) and potassium oleate were relatively nontoxic, while decanoic acid (C10) and undecanoic acid (C11) killed all second stage juveniles of the plant parasitic nematode Meloidognye hapla (the Northern root-knot nematode, which causes substantial loss in many North American crops such as strawberries, lettuce, and tomatoes) in 24 hours at a concentration of 50 ppm. For methyl esters and primary alcohols, toxicity increased with chain length up to C10. Thus, this work would direct one to consider low carbon number surfactants, and discourage the use of carbon numbers above 12.

A widely cited study on nematode control is that of E. L. Davis, D. M. Meyers, C. J. Dullum, and J. S. Feitelson, “Nematicidal Activity of Fatty Acid Esters on Soybean Cyst and Root-Knot Nematodes,” Journal of Nematology, Vol. 29, Issue 4S (supplement), pp. 677-684, 1997. The researchers found that the C9 fatty acid, pelargonic acid (nonanoic acid) had nematicidal activity. Methyl and ethylene glycol derivatives of the acid were tested. “Methyl perlargonate was more effective in reducing tomato root galling by M. javanica in laboratory bioassays compared to glycol pelargonate. It has been suggested by Dijan et al. (1994 [Pesticide Biochemistry and Physiology, Vol. 50, pp. 229-239, as cited by Davis et al.]) that the physical properties of methyl esters of fatty acids as compared to ethyl esters promote increased permeation into nematodes with a resultant increase in toxicity” (p. 682). The methyl ester was substantially more effective, producing reduced galling of plants at one eighth the concentration at which the ethyl ester was active (0.8 microliters/liter versus 6.4 microliters/liter). The authors cite the work of Jalal and Reed (1983 [Plant and Soil, Vol. 70, pp. 257-272]) who “suggested that the inhibitory effects of fatty acids of intermediate chain length that have been observed in biological systems may involve a direct interaction between the fatty acids and lipophilic regions of the target plasma membranes”—a possibility that the authors suspected may be related to the mechanisms involved in their work (p. 682). This widely cited reference would direct one to consider C9 surfactants and to prefer a methyl ester over an ethyl ester (methoxylated over ethoxylated).

U.S. Pat. No. 5,698,592, “Materials and Methods for Controlling Nematodes,” describes fatty acid ester compounds for controlling nematodes at concentrations which are non-phytotoxic. These esters have alkyls chains with 9 to 14 carbons.

U.S. Pat. Nos. 5,674,897; 5,698,592; and U.S. Pat. No. 6,124,359 describe microemulsions containing fatty acid esters for use as nematicides. These fatty acid esters are fatty acids having 8 to 14 carbons in their alkyl chains. They do not appear to include glyceride esters. Various other patents disclose the use of alkoxylated materials and other emulsifiers for use in pesticides or herbicides intended for application to plants. These include U.S. Pat. Nos. 4,975,110 and 5,098,467 to Safer; U.S. Pat. No. 5,827,522 to Troy and U.S. Pat. No. 6,093,681 to Monsanto.

Methyl esters of fatty acids have been proposed as nematicides. U.S. Pat. No. 6,887,900, herein incorporated by reference to the extent that it is noncontradictory herewith, describes methods for controlling unwanted nematodes, the method comprising administering to mammals, plants, seeds or soil a nematicidal composition comprising an effective amount of a fatty acid methyl ester selected from the group consisting of: ricinoleic acid methyl ester, crepenynic acid methyl ester, and vernolic acid methyl ester, and an aqueous surfactant. Methyl esters of fatty acids generally remain highly lipophilic compared to ethyl esters which can have multiple ethoxy groups in a long chain.

U.S. Pat. No. 6,903,052, “Nematicidal Compositions and Methods,” issued Jun. 7, 2005 to Williams, Kloek, and Hresko, herein incorporated by reference to the extent that it is noncontradictory herewith, discusses the use of certain compounds related to fatty acids to control nematodes. The compounds are generally predicted inhibitors of nematode delta-12 fatty acid desaturases and can be from C16 to C20 in length. In the Williams et al. patent, the preferred fatty acid esters have a cis (Z) or a trans (E) carbon double bond at the delta-9 position (i.e., between C9 and C10 counting from the carbonyl carbon (C═O)) and a variety of modifications at the C12, C13 or both C12 and C13 positions. Listed examples include, ricinoleic acid methyl ester (12-hydroxy-cis-9-octadecenoic acid methyl ester), ricinelaidic acid methyl ester (12-hydroxy-trans-9-octadecenoic acid methyl ester), vernolic acid methyl ester ((12,13)-epoxy-cis-9-octadecenoic acid methyl ester), 12-oxo-9(Z)-octadecenoic acid methyl ester and crepenynic acid methyl ester (9(Z)-octadecen-12-ynoic acid methyl ester). Specifically excluded are the normal substrates of delta-12 desaturases (e.g., cis-9-octadecenoate (oleate), cis-9-hexadecenoate (palmitoleate), isomers of the substrate such as trans-9-octadecenoate (elaidate) and the normal products of delta-12 desaturases (e.g., cis-9,12-octadecadienoate (linoleate), cis-9,12-hexadecadienoate). Fatty acid compounds where the only modifications are a single cis or trans double bond at the delta-9 position (i.e., a cis or trans double bond between C9 and C10), or double bonds at both the delta-9 (cis or trans double bond between C9 and C10) and delta-12 positions (i.e., a cis or trans double bond between C12 and C13) as well as certain naturally occurring esters such as triglycerides, diacylglycerides and phospholipids are generally not preferred.

Linear alcohol ethoxylates (nonionic surfactants formed by ethoxylation of alcohols) have been studied for potential insecticidal functionality. These compounds have the general chemical structure RO(CH2CH2O)nH, where R is the hydrophobic alkyl chain and n is the number of ethoxy groups added (added, for example, via reaction with ethylene oxide). Steven R. Sims and Arthur G. Appel, “Linear Alcohol Ethoxylates: Insecticidal and Synergistic Effects on German Cockroaches (Blattodea: Blattelllidae) and Other Insects,” Journal of Economic Entomology, Vol. 100, No. 3, pp. 871-879 (2007), reports a study of sixteen linear ethoxylated alcohol surfactants (AEOs) in terms of contact insecticidal activity against adult German cockroaches. Within groups of equal carbon numbers (carbon chain length), the 24-hour mortality after treatment “was inversely related to the amount of ethoxylation. There was a highly significant negative relationship between the hydrophile-lipophile balance (HLB) value of the AEO and contact toxicity. The AEO with the lowest HLB value, Tomadol 23-1 (HLB 32 3.7), produced the greatest 24-h cockroach mortality.” Their regression and data (FIG. 2 of Sims and Appel) point to less than about 30% mortality for an HLB value greater than about 11. As for chain length, the authors state (p. 874): “As ethoxylation increased within a series, mortality decreased.” Further, “Within a series of four AEOs sharing similar degrees of ethoxylation (2.5 or 3 mol) toxicity, measured by LT50, decreased with an increase in the average length of the alkyl group . . . .” Linear regression yielded a relationship between toxicity and carbon chain length that was statistically significant. However, Sims and Appel cite several other studies for fish and other aquatic species suggesting that toxicity has been found to increase with increasing carbon number in AEOs. Some of the data and information from the work of Sims and Appel is contained in US 2006/0057173, “Insecticide Compositions and Process,” published March 16, 2006 by Steven R. Sims, herein incorporated by reference in its entirety to the extent it is consistent herewith, with FIGS. 1 and 2 and the associated discussion of toxicity as a function of carbon number and HLB being of particular interest (i.e., paragraphs 9-11 and 18). The Sims patent teaches the use of surfactants with a chain of 15 or less carbon atoms, and suggests that past work pointing to increased toxicity with increasing carbon was based on tests with up to 14 carbons and should not be extrapolated: “Not all studies demonstrate increasing toxicity with increasing alkyl chain length. Schott (1973, J. Pharm. Sci. 62:341-343) hypothesized that maximum toxicity should occur in intermediate members of a homologous series of anionic surfactants since ‘active’ monomeric (non-micellar) molecules are limited by the critical micelle concentration and decreasing solubility as alkyl chain length increases. Baillie et al., (1989, Inter. J. Pharm. 53:241-248) provided data supporting this theory using a series of polyoxyethylene alkyl ethers and motility inhibition of the protozoan Tetrahymena elliotti.”

Alcohol ethoxylates for agricultural treatments are also described in U.S. Pat. No. 6,300,282, “Technique for Reducing Nitrogen Leaching in Soils and Improving Potato Crop Yield by Application of Surfactants to Crop Root Zone,” issued Oct. 9, 2001 to Eric Thomas Cooley, herein incorporated by reference to the extent that it is noncontradictory herewith. The Cooley patent describes potato treatments for increasing potato crop yields and/or minimizing nitrate leaching of potato crop acreage that involves the application of surfactant at planting to the soil adjacent a seed potato. One mentioned surfactant is Preference™, a non-ionic surfactant blend containing soybean based fatty acid and alcohol ethoxylates available from Cenex/Land O'Lakes Agronomy Company of St. Paul, Minn. The improved potato crop yields are believed to result from the maintenance of soil moisture levels near the potato plant root zone and/or the prevention of nitrogen and other nutrient-leaching from the potato plant root zone.

While past work has explored the role of fatty acids, ethoxylated alcohols, and related materials for various pesticidal purposes, such work generally points to low carbon number surfactants and low HLB numbers. Such conclusions, however, did not help to substantially overcome a major limitation in the prior art, namely, the need for bio-derived surfactants for agricultural and horticultural treatments that reduce many of the environmental and human health risks associated with conventional pesticides.

### SUMMARY

A surprising discovery has been made contrary to some aspects of general understanding in the agricultural and pesticidal arts, showing that relatively non-toxic, bio-derived surfactants obtained from naturally occurring lipids such as vegetable oils can be used effectively to replace at least some uses of methyl bromide or other conventional harmful pesticides. Such surfactants may comprise fatty acid esters and fatty alcohol ethers, and can have relatively high carbon numbers and/or high HLB values. While some related bio-derived surfactants have been used as adjuvants in some pesticide formulations, they are not believed to have been previously considered as effective replacements for methyl bromide or other environmentally harmful soil pesticides due to the general understanding that they are relatively nontoxic. The present discovery was not based upon consideration of past work on surfactants and insect populations, but was found though serendipity in exploring the cleaning effects of certain biobased cleaning compounds derived in part from vegetable oils. The first such observation, based on work done in the southern United States, was that plants in areas that had been treated with a bio-derived surfactant composition showed better growth. The surfactant was applied to a water tank in hopes of reducing mold growth. The dilute aqueous surfactant solution was then used for cleaning the outer surfaces of a home. Not only did the plants near the treated surfaces show improved vitality, but there was a second observation that insects entering the home from the outside were substantially reduced in number. This discovery inspired consideration of the possibility that a safe, “green” composition being used for cleaning purposes might have unexpected uses in agriculture and horticulture, including pesticidal uses.

Further exploration of the effects of said cleaning compounds led to the surprising discovery that they were highly effective against a variety of harmful soil pests that afflict citrus crops and other crops, including parasitic nematodes, which are not insects. In spite of the biobased compounds being relatively mild and non-toxic with respect to humans, and in spite of past teachings that might suggest such compounds would not be effective, a series of experiments has confirmed that the compounds of the present invention can be used against a variety of pests, including parasitic nematodes, root weevils (e.g., Diaprepes abbreviatus), etc.

What has been particularly surprising is that the bio-derived surfactants of the present invention typically are not directly toxic to insect pests such as root weevil larvae, yet are nevertheless effective in reducing damage from these pests. Traditional toxicity tests used to identify potential pesticides measure the kill rate or the lethal dose to kill a portion of the population, but may overlook other benefits outside of lethal toxicity. We have observed, for example, that some bio-derived surfactant solutions that do not kill root weevils nevertheless cause them to be substantially less active and less healthy, bringing substantial benefits in reducing plant damage without being lethal. Thus, we propose that the potential of bio-derived non-lethal surfactants in insect control has not been recognized in the past in part because of the generally low toxicity of such compounds toward various species as measured with standard toxicological methods.

Further, we have surprisingly found that some bio-derived surfactants and compositions within the scope of the present invention share some of the broad-spectrum efficacy of methyl bromide in the sense that they can be effective against two or more classes of pests such as nematodes, insect larvae or pupae, and weeds. Yet also surprisingly, some such compounds have low phytotoxicity, unlike methyl bromide, such that effective amounts of the bio-derived pesticidal compounds can be applied directly to crops or other plants, or to the soil around growing plants, without serious harm to the desired plant.

In some embodiments of the present invention, the bio-derived surfactants useful for agricultural and horticultural treatments have relatively high HLB values, such as about 6 or greater, about 8 or greater, about 10 or greater, or about 12 or greater. In another embodiment, the bio-derived surfactants of the present invention may comprise ethoxylated lipids having at least five ethoxy groups joined to each fatty acid moiety.

The invention is directed to methods of applying bio-derived compositions to soil or plants, wherein the bio-derived compositions comprise surfactants derived from natural lipids, such as vegetable oils and naturally occurring fatty acids or their naturally occurring derivatives such as mono-, di-, or triglycerides or phospholipids. In some embodiments, agricultural and horticultural treatments comprise application of bio-derived surfactants obtained from natural oils such as soybean and castor oils, wherein the surfactants are obtained by processes that typically include esterification of the oils to add alkoxy groups such as methoxy, ethoxy, or propoxy groups. In one version, the surfactants are obtained by reactions that include hydrolysis, esterification of the liberated fatty acids with methanol, and then hydrogenation to create a fatty acid alcohol. Fatty alcohols can be prepared from natural fatty acids with a variety of other technologies. In any case, the alcohols may then be further modified by reaction with ethylene oxide to add a plurality of ethoxy groups, forming a polyethoxy ether. Polyoxy ethers with relatively high HLB values can be formed from fatty alcohols via reaction with other known reactants as well to form, for example, surfactants with multiple propoxy groups, butoxy groups, etc. In other cases, transesterification of a fatty acid ester with a variety of linear chain or other alcohols may be involved, followed by conversion of the ester to an alcohol. In some embodiments, the bio-derived surfactants have aliphatic chains with relatively high carbon numbers, such as 14 or more carbons, 16 or more carbons, or 18 or more carbons. In one embodiment, the carbon number is from 16 to 18, and in a related embodiment, the bio-derived surfactant primarily comprises surfactants having a carbon number of 16 or 18, or more specifically, a carbon number of 18.

In another embodiment, the bio-derived surfactant comprises an ethoxylated fatty acid or fatty alcohol, wherein the fatty acid or alcohol has a carbon number of sixteen or greater and at least 5 ethoxy groups, specifically at least 10 ethoxy groups, and more specifically at least 20 ethoxy groups, such as between 5 and 80 ethoxy groups, or between 10 and 60 ethoxy groups, or between 15 and 55 ethoxy groups. In one embodiment, the bio-derived surfactant is obtained by esterification or epoxidation of soybean or castor oil, or of fatty alcohols obtained therefrom. More generally, but by way of example only, the bio-derived surfactant may be derived from any of the following lipids: soybean oil, castor oil, cottonseed oil, linseed oil, canola oil, safflower oil, sunflower oil, peanut oil, olive oil, sesame oil, coconut oil, walnut oil or other nut oils, flax oil, neem oil, meadowfoam oil, other seed oils, fish oils, animal fats, and the like. Exemplary fatty acids include omega-3 fatty acids such as alpha-linolenic acid, stearidonic acid, eicosapentaenoic acid, docosahexaenoic acid, and so forth; omega-6 fatty acids such as linoleic acid, gamma-linolenic acid, dihomo-gamma-linolenic acid, arachidonic acid, calendic acid, and the like; omega-9 fatty acids such as oleic acid, erucic acid, elaidic acid, and the like; saturated fatty acids such as myristic acid, palmitic acid, stearic acid, dihydroxystearic acid, arachidic acid (eicosanoic acid), behenic acid (docosanoic acid), lignoceric acid; and other fatty acids including various conjugated linoleic acids, omega-5 fatty acids such as myristoleic acid, malvalic acid, sterculic acid. Natural waxes or the fatty acids therefrom may also be used, particularly ester waxes such as straight chain ester waxes; examples include jojoba oil, carnauba wax, beeswax, candellia wax, and the like. Fatty alcohols can be obtained from any of these fatty acids by any known method, including catalytic conversion, esterification plus hydrogenation, etc.

In some embodiments, the bio-derived surfactants of the present invention comprise surfactants derived from naturally occurring fatty acids and fatty alcohols that are unsaturated, such as omega-3, omega-six, or omega-nine fatty acids, and wherein the aliphatic tail of the surfactant has not been hydrogenated, such that it has remained unsaturated. The iodine number test can be used to assess the degree of saturation. Generally, a highly saturated fatty acid will have an iodine value of less than 5 (e.g. less than 2).

In some embodiments, bio-derived surfactants are obtained from two or more vegetable oil sources, such as from mixtures of any two or more of the vegetable oils mentioned herein. Alternatively, two or more vegetable oils may be reconstituted to form a reconstituted oil according to known methods such as those described in U.S. Pat. No. 6,258,965, “Reconstituted Meadowfoam Oil,” issued Jul. 10, 2001 to A. J. O'Lenick, Jr., and U.S. Pat. No. 6,013,818, “Reconstituted Meadowfoam Oil,” issued Jan. 11, 2001 to A. J. O'Lenick, Jr., both of which are herein incorporated by reference to the extent that it is noncontradictory herewith. The O'Lenick patents describe processes in which one or more oils of natural origin are transesterified under conditions of high temperature in the presence of a catalyst to make a “reconstituted product” having an altered alkyl distribution and consequently altered chemical and physical properties. While surfactants obtained from natural lipids are useful, it is recognized that identical materials obtained from synthetic raw materials can be created and, in some embodiments, are within the scope of the present invention.

In one embodiment, the compositions of the present invention can include a mixture of the water blended in any suitable ratio with the following compounds:
20 to 100 parts of a polyethoxylated fatty acid or fatty alcohol obtained from a vegetable oil, with an average degree of ethoxylation greater than 10 (greater than 10 ethoxy groups per fatty acid chain).
0 to 100 parts of a vegetable oil methyl ester.
0 to 100 parts vegetable oil.
0 to 10 parts pentanedioic acid, dimethyl ester.
0 to 10 parts butanedioic acid, dimethyl ester.
0 to 10 parts hexanedioic acid, dimethyl ester.
0 to 50 parts polyoxyethylene tridecyl ester.
0 to 20 parts ethoxylated alkylaryl phosphate ester.

The treatments of the present invention can be further enhanced through the additional application of carbon dioxide, such as by carbonating the water used to form the solution or carbonating the solution after all or most of its components have been mixed together. Carbonation can be used to deliver carbon dioxide into the soil where it can enhance the available carbon dioxide for root uptake, or where it may enhance the pesticidal effects of the solution. For example, in some cases the presence of carbon dioxide (e.g., as gas bubbles, in solution as carbonic acid, etc.) or its reaction products (carbonates, etc.) can help mitigate the effects of harmful fungi, bacteria, larvae, nematodes, etc. Our observations indicate that carbon dioxide can paralyze or reduce the activity of many living pests, and, without wishing to be bound by theory, suggest that the presence of elevated levels of carbon dioxide or its reaction products at concentrations sufficient to reduce activity or defenses of some pests may make the pests more susceptible to the harmful effects of the bio-derived surfactants or other components of the aqueous solutions for treatments according to the present invention. In some embodiments, carbon dioxide gas may be applied directly onto or into the soil, either during, before, or after treatment with the aqueous solutions of the present invention, such that elevated levels of carbon dioxide or its reaction products are present in the soil that is treated with bio-derived surfactants.

### DEFINITIONS

As used herein, “bio-derived” compounds are those produced from a naturally occurring substance obtained from a plant, animal, or microbe, and then modified via chemical reaction. Modification can include esterification of fatty acids (e.g., ethoxylation, methoxylation, propoxylation, etc.), transesterification of an oil (e.g., reaction of an alcohol with a glyceride to form esters of the fatty acid portions of the glycerides), etc. Hydrogenation or other steps may also be considered.

As used herein, “chemical pesticides” are synthetic compounds with pesticidal activity against pests such as insects, nematodes, fungus, weeds, bacteria, etc. Pesticidal activity is expressed through directly killing or inactivating the pest. Most conventional pesticides are chemical pesticides. Various types of chemical pesticide can include organophosphate pesticides (pesticides that affect the nervous system by disrupting the enzyme that regulates acetylcholine, a neurotransmitter), carbamate pesticides (agents that attack the nervous system by disrupting an enzyme that regulates acetylcholine), organochlorine insecticides (e.g., DDT and chlordane), pyrethroid pesticides (synthetic versions of the naturally occurring pesticide pyrethrin), etc.

As used herein, “biopesticides” are pesticidal agents obtained from natural materials such as animals, plants, bacteria, and certain minerals. For example, canola oil and baking soda have pesticidal applications and are considered biopesticides by the EPA. Classes of biopesticides include microbial pesticides having a microorganism (e.g., a bacterium, fungus, virus or protozoan) as the active ingredient; plant-incorporated-protectants (PiPs) produce from genetic material that has been added to a plant; and biochemical pesticides that occur naturally and control pests by non-toxic mechanisms. Biochemical pesticides include substances, such as insect sex pheromones, that interfere with mating, as well as various scented plant extracts that attract insect pests to traps. Because it is sometimes difficult to determine whether a substance meets the criteria for classification as a biochemical pesticide, EPA has established a special committee to make such decisions.

As used herein, “essential oil” is defined as a volatile and frequently aromatic liquid obtained from plants and seeds, including but not limited to cotton seed oil, soybean oil, cinnamon oil, corn oil, cedar oil, castor oil, clove oil, geranium oil, lemongrass oil, linseed oil, mint oil, sesame oil, thyme oil, rosemary oil, anise oil, basil oil, camphor oil, citronella oil, eucalyptus oil, fennel oil, ginger oil, grapefruit oil, lemon oil, mandarin oil, orange oil, pine needle oil, pepper oil, rose oil, tangerine oil, tea tree oil and tea seed oil, or individual components thereof such as benzaldehyde, cinnamaldehyde, etc.

As used herein, “soil” refers to all media capable of supporting the growth of plants and may include humus, sand, manure, compost and the like. Soil may be substantially uniform in properties or substantially heterogeneous at a variety of scales. For example, there may be multiple strata such as a layer of sandy soil above a less permeable layer of clay-rich soil. There may also be aggregates of differing soil types, or clumps of matter such as vegetable matter, clays, minerals, fertilizers, etc., dispersed within the soil. The soil may also contain manmade ducts, tubes, pipes, shafts, etc., for convenient irrigation or treatment with nutrients, pesticides, etc., though such structures are generally understood to not be part of the soil itself. The soil may be substantially flat, in mounds, interspersed with furrows, in pots or other containers, in the outdoors or in a greenhouse, etc. In some cases, the soil is part of an outdoor agricultural field dedicated to growing of one or more marketable crops. Such a field may have an area of at least 1 hectare, at least 10 hectares, or at least 100 hectares, such as from 10 to 100,000 hectares or from 100 to 10,000 hectares. The field may comprise a single contiguous area or may be broken up into a plurality of nearby units controlled by the same entity.

### DESCRIPTION

### The Composition and Methods of Making

Formation of a bio-derived surfactant from a naturally occurring lipid can be done by any known method such as esterification, Fischer esterification, epoxidation, etc. Prior to the formation of a surfactant, fatty acids may be liberated from natural lipids by, for example, triglyceride hydrolysis, which separates the fatty acids from glycerol. The fatty acids may then be reacted to yield the bio-based surfactants useful in the present invention, including fatty alcohol ethoxylates or other high HLB-value surfactants derived from fatty alcohols. In one version, a reaction is performed of fatty acids is with an alcohol or an epoxide. Exemplary alcohols include methanol, ethanol, propanol, and other primary or secondary alkyl alcohols.

In ethoxylation, ethylene oxide is added to fatty acids or fatty alcohols, typically in the presence of potassium hydroxide, resulting in the addition of multiple ethoxy groups to the molecule. In order to obtain a bio-derived surfactant with a relatively high HLB value that is the product of a natural lipid, ethoxylation is a useful technique because a chain of hydrophilic ethoxy groups can be readily added to the molecule. Thus, in many embodiments of the present invention, the bio-derived surfactants are obtained through a simple operation or small number of operations from the natural raw materials themselves, such as via hydrolysis and esterification (e.g., ethoxylation) or via esterification alone. In other embodiments, a hydrogenation step may also be included prior to or after esterification (e.g in the formation of alcohols, hydrogenation may follow methylation of a fatty acid).

Bio-derived surfactants may be produced from any known method of ethoxylating triglycerides such as vegetable oils, including the methods discussed in U.S. Pat. No. 6,268,517, “Method for Producing Surfactant Compositions,” herein incorporated by reference to the extent that it is noncontradictory herewith.

In one embodiment, the bio-derived surfactant is an ethoxylated mono-, di-, or triglyceride prepared by the condensation of ethylene oxide with a mono-, di-, or triglyceride. The reaction may be performed using from 5-70 moles, 10-50 moles, or 20-50 moles of ethylene oxide per mole of mono-, di-, or triglyceride. The resulting condensation product may have a melting point of at least 15° C., at least 25° C., or at least 30° C.

As discussed by Ernst W. Flick in Industrial Surfactants, 2nd ed., p. 230, ethoxylated fatty acids and polyethylene glycol fatty acid esters are nonionic mono and diesters of various fatty acids, typically prepared by the condensation or addition of ethylene oxide to a fatty acid at the site of the active hydrogen or by esterification of the fatty acid with polyethylene. glycol. The chemical structure of the monoester product is generally R—CO—(O—CH2CH2)n-OH where R—CO represents the hydrophobic base and n denotes the mole ratio of oxyethylene to the base. The diester product has a chemical structure of R—CO—(O—CH2CH2)n-O—CO—R.

U.S. Pat. No. 6,300,508, “Thickened Aqueous Surfactant Solutions,” issued Oct. 9, 2001 to Raths, Milstein, and Seipel, herein incorporated by reference to the extent it is compatible herewith, describes a method for the production of fatty acid esters of an ethylene-propylene glycol of the formula R1 COO(EO)x(PO)y(EO)zH wherein R1 CO is a linear aliphatic, saturated or unsaturated acyl group, or a combination thereof, having from about 6 to about 22 carbon atoms (though a more specific range of 14 to 22 or 16 to 22 carbon atoms may be considered for the purposes of the present invention), EO is —CH2CH2--, and PO is —CH2CH(CH3)O— or —CH2CH2CH2O— or a combination thereof. The method of U.S. Pat. No. 6,300,508 comprises reacting a fatty acid having from about 6 to about 22 carbon atoms with an alkylene oxide selected from the group consisting of propylene oxide, ethylene oxide or a combination thereof, in the presence of an alkanolamine. For some embodiments of the present invention, the use of additional moles of alkylene oxide reactants relative to the recommendations of U.S. Pat. No. 6,300,508 may be considered to increase the degree of ethoxylation or propoxylaytion and thereby increase HLB.

U.S. Pat. No. 6,221,919, “Utilization of Ethoxylated Fatty Acid Esters as Self-Emulsifiable Compounds,” issued Apr. 24, 2001 to G. Trouve, herein incorporated by reference to the extent that it is noncontradictory herewith, discloses methods of producing ethoxylated fatty acid esters that may have one or more of the following three formulas:

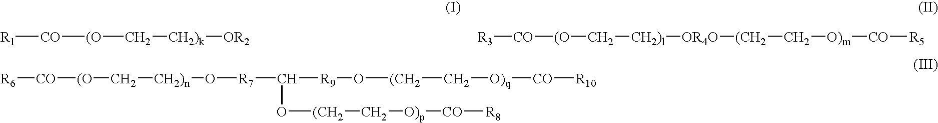

where R1, R3, R5, R6, R8 and R10 represent a linear or branched, saturated or unsaturated hydrocarbon chain having from 5 to 30 carbon atoms (for the purposes of the present invention, these may more specifically have from 14 to 30 carbon atoms), and R2, R4, R7 and R9 represent a linear or branched, saturated or unsaturated hydrocarbon chain having from 1 to 5 carbon atoms. U.S. Pat. No. 6,221,919 teaches that the values of k, l+m, and n+p+q should be adapted to give HLB values between about 4 and about 10, preferably neighboring 5, although higher HLB values are within the scope of the present invention, so elevated values of k, l+m, and n+p+q may be useful.

Example 2 described by U.S. Pat. No. 6,221,919 is specifically incorporated herein by reference, for it describes ethoxylation of rapeseed oil via a process that may be useful for a variety of other vegetable oils within the scope of the present invention.

Ethoxylation is most easily performed by direct condensation reactions with ethylene oxide with fatty acids or fats themselves. Ethoxylation can also be carried out on fatty acid methyl esters if the appropriate catalysts are used, as described by I. Hama, T. Okamoto and H. Nakamura of Lion Corporation, Tokyo, Japan, in “Preparation and Properties of Ethoxylated Fatty Methyl Ester Nonionics,” Journal of the American Oil Chemists' Society, Vol. 72, No. 7, July, 1995, pp. 781-784. Their method directly inserts EO into fatty methyl esters (RCOOCH3) to give [RCO(OCH2CH2)nOCH3] using a solid catalyst modified by metal cations. Ethoxylates of fatty methyl esters obtained by this method were homogeneous monoesters and had good properties as nonionic surfactants.

Fischer esterification involves forming an ester by refluxing a carboxylic acid and an alcohol in the presence of an acid catalyst. Typical catalysts for a Fischer esterification include sulfuric acid, tosic acid, and lewis acids such as scandium(Ill) triflate or dicyclohexylcarbodiimide.

Vegetable oils, after basic purification, can be processed to produce methylated or ethylated seed oils, commonly referred by the abbreviations MSO and ESO, respectively, which typically have a single moiety added, unlike epoxidation reactions which can add numerous groups. MSO's and ESO's are created by hydrolysis of the glycerol molecule from the fatty acids, and the acids are then esterified with methanol or ethanol. Such compounds can be used in the scope of the present invention, but when higher HLB values are desired, additional hydrophilic groups should be added.

Examples of commercially available compositions comprising bio-derived surfactants that may be used within the scope of the present invention include:

SC-1000™, a surface washing agent marketed by GemTek Products (Phoenix, Ariz.). SC-1000™ is part of GemTek's SAFE CARE® product series, that are said to contain alcohols, fatty acids, esters, waxes, saponifiers, chelators, enzymes and other fractions from soy, corn, palm kernel, peanut, walnut, safflower, sunflower, Canola, and cotton seed, as described at http://www.gemtek.com/pdf/2005-SAFECARE Brochure. pdf, as viewed Nov. 26, 2007.

SoyFast™ Manufacturer's Base marketed by Soy Technologies (Nicholasville, Ky.) as a soy-based biodegradable all-purpose cleaner, and related soy-based products such as SoyFast™ Cleaner and SoyGreen™ Solvents. Manufacturer's Base, according to its MSDS, comprises two bio-derived surfactants, ethoxylated castor oil (average degree of ethoxylation said to be about 30) and soybean oil methyl ester (formed by reaction of soybean oil with methanol, resulting in hydrolysis of the triglyceride to yield methylated fatty acids and glycerol). It also comprises pentanedioic acid, dimethyl ester; butanedioic acid, dimethyl ester; hexanedioic acid, dimethyl ester; and polyoxyethylene tridecyl ester.

Soy-Dex Plus marketed by Helena Chemical Co. (Memphis, Tenn.), said to be a proprietary blend of vegetable oil, polyol fatty acid ester, polyethoxylated esters thereof, and ethoxylated alkylaryl phosphate ester.

Esterified vegetable oils, for example from Cognis Corp. (Monheim, Germany), described on page 5 of http://www.cognis.com/NR/rdonlyres/C313D62045B5-4AEE-834A-8294C94623C9/0/AS ProductCatalogue A4 070801 reduced.pdf (as viewed Nov. 2, 2007), including AGNIQUE SBO-10 Ethoxylated Soybean Oil, POE 10; AGNIQUE SBO-30 Ethoxylated Soybean Oil POE 30; AGNIQUE SBO42 (Trylox 5919-C) Ethoxylated Soybean Oil, POE 42; AGNIQUE SBO-60 Ethoxylated Soybean Oil POE 60; AGNIQUE CSO44 (Mergital EL 44) Ethoxylated Castor Oil, POE (polyoxyethylene) 44; AGNIQUE CSO-60H (Eumulgin HRE 60) Hydrogenated Ethoxylated Castor Oil, POE 60; AGNIQUE CSO-200 (Etilon R 200) Ethoxylated Castor Oil, POE 200; AGNIQUE RSO-0303 (Eumulgin CO 3522) Alkoxylated Rapeseed Oil, POE 3, POP (polyoxypropylene) 3; AGNIQUE RSO-2203 (Eumulgin CO 3526) Alkoxylated Rapeseed Oil, POE 3, POP 22; AGNIQUE RSO-30 (Eumulgin CO 3373) Ethoxylated Rapeseed Oil, POE 30. Also, Ethoxolated Soybean Oil, marketed by Adjuvants Unlimited of Memphis, Tenn., as AU970 could be used.

TOXIMUL® ethoxylated castor oils from Stepan Chemical (Northfield, Illinois), including TOXIMUL® 8240 (POE-36), TOXIMUL® 8241 (POE-30), and TOXIMUL® 8242 (POE40).

Genapol surfactants by Hoechst Chemical, such as Genapol OXD-080, a fatty alcohol polyglycol ether.

Ethoxylated castor oil is available as Shree Chem-Co 35 from Shree Vallabh Chemicals (Gujarat, India). In Shree Chem-Co 35, the hydrophobic constituents comprise about 83% of the total mixture, the main component being glycerol polyethylene glycol ricinoleate. Other hydrophobic constituents include fatty acid esters of polyethylene glycol along with some unchanged castor oil. The hydrophilic part (17%) consists of polyethylene glycols and glycerol ethoxylates. In a related compound, Shree Chem-Co 40, approximately 75% of the components of the mixture are hydrophobic. These comprise mainly fatty acid esters of glycerol polyethylene glycol and fatty acid esters of polyethylene glycol. The hydrophilic portion consists of polyethylene glycols and glycerol ethoxylates.

Ethoxylated castor oil and hydrogenated castor oil products marketed by Global Seven Corp. (Franklin, N.J.), as described in the Global Seven Product Guide at http://www.global7.com/brochure.pdf, as viewed Nov. 15, 2007. These products, marketed as emulsifiers, solubilizers, and conditioners, include HETOXIDE C-200, a PEG-200 castor oil compound said to have an HLB of 18.1; HETOXIDE C-81, a PEG-81 castor oil compound said to have an HLB of 15.9; HETOXIDE C40, a PEG40 castor oil compound said to have an HLB of 13.0; HETOXIDE C-30, a PEG-30 castor oil compound said to have an HLB of 11.8; HETOXIDE C25, a PEG-25 castor oil compound said to have an HLB of 10.8; HETOXIDE C-16, a PEG-16 castor oil compound said to have an HLB of 8.6; and HETOXIDE C-5, a PEG-5 castor oil compound said to have an HLB of 4.0.

In one embodiment, the bio-derived surfactants of the present invention comprise surfactants obtained by esterification of vegetable lipids. In a particular embodiment, the lipids are selected from soybean oil and castor oil. These may also be derived from single cell organisms, such as bacteria, algae, yeast, and fungi. The major unsaturated fatty acids in soybean oil triglycerides are 7% linolenic acid (C18:3); 51% linoleic acid (C-18:2); and 23% oleic acid (C-18:1). Castor oil is a triglyceride in which about 85% to 95% of the fatty acids are ricinoleic acid (C18:1-OH), about 2% to 6% are oleic acid (C-18:1), about 1% to 5% is linoleic acid (C-18:2), with there being about 0.3% to 1% each of linolenic acid (C18:3), stearic acid (C18:0), palmitic acid (C16:0), and dihydroxystearic acid, with small amounts of some other acids.

Additional steps, such as hydrogenation and dehydrogenation may also be contemplated. In one embodiment, the bio-derived compound comprises an ester of a fatty acid, wherein the fatty acid has not been chemically modified apart from the formation of an ester bond to join the fatty acid to a hydrophilic moiety. Alternatively a bio-derived surfactant useful in some embodiments of the present invention may be the ethoxylated product of a naturally occurring fatty acid or lipid.

The aqueous composition, as applied to the soil, to weeds, directly on pests, or to crops or other plants, may comprise any effective amount of the bioderived surfactant, such as at a concentration of least about any of the following:
0.05%, 0.1%, 0.2%, 0.3%, 0.5%,1%,1.5%, 2%, 3%, 5%, 10%, or 20%. The concentration may also be less than about any of the following 100%, 50%, 25%, 20%, 10%, 5%, and 3%, and ranges may be formed from any suitable pair of the aforementioned upper and lower bounds, such as from about 0.1% to about 15%.

Other biobased or natural surfactants may be included, such as the rhamnolipids and rhamnolipid derivatives marketed by Jeneil Biosurfactant Company (Saukville, Wis.), such as JBR425 (CAS Number: 147858-26-2) as well as those described in U.S. Pat. No. 5,455,232, “Pharmaceutical Preparation Based in Rhamnolipid,” issued Oct. 3, 1995 to Piljac and Piljac, or in U.S. Pat. No. 7,129,218, “Use of Rhamnolipids in Wound Healing, Treatment and Prevention of Gum Disease and Periodontal Regeneration,” issued Oct. 31, 2006 to Stipcevic et al. Lipopeptide biosurfactants such as those produced by Bacillus species may also be included. Natural plant oils may be provided in the form of oil cakes that can be used in combination with the materials of the present invention.

Buffering agents or acidifiers may also be present. Other ingredients may include oils, emulsifiers, thickeners, film-forming agents, particles such as zeolites, calcium carbonate, mica, etc., as well as fertilizers, nutrients, beneficial bacteria, etc.

Plant oils that can be used in the mixture or in additional treatments, including oil cake treatments, can comprise a variety of plant oils such as neem, castor, soybean, mustard, karanj, mahua, etc. Self-emulsifiable esterified fats and fatty acids may also be used, including those prepared according to the principles taught in U.S. Pat. No. 6,221,919, “Utilization of Ethoxylated Fatty Acid Esters as Self-Emulsifiable Compounds,” previously incorporated by reference. The ethoxylated fatty acid esters described therein are said to form self-emulsifiable components without requiring any other surfactant, and are biodegradable.

The composition may further comprise biopesticides and other naturally occurring agents such as essential oils and botanical extracts, including the garlic extracts described in U.S. Pat. No. 6,231,865. Examples of plant extracts or related bio-derived compounds that may be useful in various embodiments of the present invention include, without limitation, grapeseed oil, lecithin, extract of tomato leaves, mustard extracts, oils and soaps derived from the Brassicacae family, clove oil and clove extracts, Burkholderia cepacia extract, neem oil or neem extracts such as Nimbecidine or other extracts or derivatives from mahogany or other trees of the genus Azadirachta, etc. When oils are included, they may be provided as an emulsion, typically as an oil in water emulsion, though aqueous components may be dispersed as a water in oil emulsion.

Another example of naturally derived materials that can be combined with the surfactants or other compositions of the present invention is given in U.S. Pat. No. 5,051,255, “Nematicidal Preparations,” issued Sep. 24, 1991 to Devidas and Crovetti, herein incorporated by reference to the extent that it is noncontradictory herewith.

Two or more compositions may be applied in sequence or substantially simultaneously, such as a pretreatment of soil with an aqueous solution and a subsequent oil-based spray applied to portions of the soil of either the same or different active ingredients.

Compatibility agents that allow simultaneous application of two or more ingredients may also be included, as desired.

Buffering agents may also be present, such as a phosphate salt or citric acid. “Water softening” agents may also be used, such as ammonium sulfate.

The method for making or using the bio-derived surfactant may include providing an antifoam such as Dow Corning A Antifoam manufactured by Dow Chemical of Midland, Mich. The anti-foam agent may be present in a concentration of about 0.1% to 1% by volume, such as about 0.5%. The use of an anti-foam agent may be helpful, for example, when the solution is to be sheared or agitated, or when it is present with carbonated water or water supersaturated with another gas. Vegetable oils, emulsified oils, other lipids, silicone oils or other agents may be present to help reduce foaming when carbonated materials are used in the presence of surfactants.

The bio-derived surfactants and related mixtures of the present invention can be effective against multiple types of pests, such as insects, nematodes, and weeds. Such wide-spectrum functionality is not required to be within the scope of the present invention, but may be advantageously achieved in some embodiments. The pests that can be targeted may include animal pests that attack roots, leaves, or other plant parts. Such pests may be repelled or inactivated with the compositions of some embodiments of the present invention. Such pests can be insects in various stages of life (larvae, etc.). In some cases, the repelled pests may be mammals (e.g., deer, moles, mice, etc.) or birds who are discouraged from consuming plant parts by the presence of the composition on leaves or other parts of the plants. Further, it has been observed in some cases that compositions of the present invention comprising bio-derived surfactants can also be effective in repelling a wide variety of insects above ground, including some flying insects.

Insect pests that can be targeted with methods and compositions of the present invention may include but are not limited to weevils such as root weevils, including citrus root weevils, pepper weevils (Anthonomus eugenii Cano), snout weevils in general, cotton weevils (boll weevil), alfalfa weevils, grain weevils, or any beetle from the Curculionoidea superfamily or beetles in other families bearing the name “weevil.”

Other pests to be targeted may include, for example, ants, chinch bugs, false chinch bugs, cutworms, the grape bud beetle or any other beetle, leaffolders, phylloxera, borers, leafhoppers, mealybugs, leafrollers, the orange tortrix, thrips, western grapeleaf skeletonizer, spiders, wasps, aphids, psyllids, tuberworm, the silverleaf whitefly, wireworms, mites such as citrus mites, armyworms, various caterpillars and moths, cockroaches, flies, mosquitoes, etc.

Nematodes to be targeted may include the citrus nematode (Tylenchulus semipenetrans), sheath nematodes (Hemicycliophora and the related Hemicriconemoides species), root knot nematodes (Meloidogyne spp.), cyst nematodes (Heterodera spp.), lesion nematodes (Pratylenchus spp.), stubby root nematodes (Trichodorus spp.), foliar nematodes (Aphelenchoides spp.), and the like.

The term “weeds” refer to any undesired plant species that interferes with the growth and harvesting of planted crops. They may be native or non-native plants (invasive weeds). Examples include broadleaf plantain, burdock, creeping charlie, dandelion, goldenrod, kudzu, leafy spurge, milk thistle, poison ivy, ragweed, sorrel, sumac, wild carrot, wood sorrel, leafy spurge, melaleuca, Old World climbing fern, giant salvinia, salt cedar, hydrilla, water hyacinth, yellow star thistle, downy brome, Brazilian pepper, jointed goat grass, purple loosestrife, and many more.

In one embodiment, a method of the present invention may produce two or more functions that effectively reduce the damage to a crop from at least two differing types of pests, the functions being selected from reducing the activity of insects, reducing the activity of nematodes, and harming weeds by at least one of preventing germination, stunting the growth of existing weeds, or killing weeds. The method in some embodiments may further be effective against disease pathogens (e.g., viruses, bacteria, and fungi).

Crops that may be assisted with the methods and compositions of the present invention may include citrus, strawberries, peppers, tomatoes, beans such as soybeans, celery, squash, grapes (e.g., Tokay grapes), melons, avocado, garden vegetables, apples and other fruit trees, etc., and a wide variety of other fruits, vegetables, legumes, tubers, grains such as corn or wheat, nuts, and the like, as well as non-edible agricultural products such as cotton, trees, grass, alfalfa, ornamental plants and trees, etc. Crops be intended for human consumption, animal consumption (including fodder), or for non-food purposes (e.g., biomass, materials for construction, drug production, etc.).

Uses of the present invention need not be limited to crops that are harvested but can also be applied to enhance plant grown for non-crop purposes such as for aesthetic and ornamental purposes, environmental management, etc.

### Methods of Use

Bio-derived compositions of the present invention may be suitable for a variety of agricultural and horticultural applications. Treated crops can include citrus crops, other fruit trees such as apples or cherries, berries such as strawberries, tomatoes, beans such as soybeans, root and tuber products such as beets and potatoes, legumes such as lentils, peanuts or peas, seed crops such as sunflowers or rapeseeds, etc. Ornamental plants, shrubs, trees, lawns, flowers, gardens in general, etc. may also be treated within the scope of the present invention.

Application to the soil may be prior to planting, or after planting but before emergence of the desired plant, or after emergence. When used for control of weeds (herbicidal applications), the bio-derived surfactant may be applied to pre-emergent or post-emergent weeds, though pre-emergent treatment should be most effective since the bio-derived surfactants of the present invention are typically relatively nontoxic to post-emergent plants. In one embodiment, an agricultural field or rows thereof are wetted or flooded with an aqueous solution of the present invention, and the crop or other desired plants are planted immediately or shortly thereafter. The delay between treatment and planting may be, for example, about 5 minutes or greater, such as from about 5 minutes to 1 week, or less than three days, less than one day, or from about 1 hour to about 2 weeks.

The compositions of the present invention can be used as replacements for methyl bromide treatment of agricultural soils. In such embodiments, a bio-derived surfactant is applied to the soil of an agricultural area prior to planting. The soil may be saturated with the solution from heavy irrigation, flooding, spraying, drip irrigation (optionally under plastic sheeting), or subsurface injection. Sufficient solution may be applied to treat a specified depth of soil, such as soil from the surface to a depth of any of 6, 12, 18, or 24 inches, or deeper, if desired. Chemigation, the technique of adding chemicals to irrigation water, may be used. Chemigation processes may use, for example, a holding tank for the liquids to be applied, hoses, fittings, couplings, a filter, plus a metering pump such as a Jaeco Fluid Systems (Malvern, Pa.) JaecoAgriPak™ packed plunger chemigation metering injection pump. Any irrigation system type may be used, such as pivot, drip, sub-surface, tape, pipe, laterals sprinkler or open ditch.

Application of the bio-derived surfactant can be in a diluted aqueous solution, or via a concentrated solution (e.g., concentrations of 10% to 100%). When a concentrated solution is applied, it may be subsequently diluted by irrigation, rainwater, etc., such that a more dilute solution is distributed through the soil.

Means of application include spraying such as hand spraying, spraying from a ground or air vehicle (e.g., tractor spraying or aerial spraying, respectively), spraying from spray rigs or blasters of various types, and spraying from spray booms to apply pesticides to trees or other plants, etc. Other application means include flooding (e.g., saturating the soil with a dilute solution such that one or more standing pools form for a period of time over a substantial portion of the ground), irrigation through furrows or other waterways, subsurface injection via buried piping or via temporary insertion of a nozzle or injector into the ground, etc. Application may be directed to specific regions of the soil, such as the soil at the base of a plant, or may be substantially uniformly applied to the soil of an agricultural tract. Examples of known devices and methods for soil treatment with a pesticide or other compounds are disclosed in US 20030159630, “Pesticide Application Tool and Method of Applying Pesticide Below Grade,” by R. R. Rollins, published Aug. 28, 2003, which discusses subterranean application of pesticides. A soil treating tool is proposed having an elongated body portion, a handle portion attached at one end of the body portion and an applicator portion attached to the other end of the body portion. The applicator portion is sized and shaped for insertion under soil and for forming an opening in the soil by lateral movement of the handle portion. The applicator portion defines at least one fluid outlet. A fluid inlet is provided in fluid communication with the applicator portion, such that fluid applied under pressure to the inlet is dispensed from the fluid outlet. A method for the subterranean application of pesticides with the device of Rollins is also described.

U.S. Pat. No. 6,877,272, “Method of Applying Pesticide” by T. Hoshall, issued Apr. 12, 2005, herein incorporated by reference to the extent that it is noncontradictory herewith, describes a method for delivering a pesticide adjacent a foundation of a structure. The method includes injecting the pesticide into a tubular conduit positioned proximate to the foundation of the structure. The pesticide is injected into the tubular conduit at a rate such that the internal pressure of the tubular conduit remains below a threshold pressure of the tubular conduit until the tubular conduit is substantially filled with the pesticide thereby preventing the pesticide from being discharged through pores of the tubular conduit as the tubular conduit is being filled with the pesticide. Continued injection of pesticide into the tubular conduit causes the tubular conduit to be uniformly pressurized above the threshold pressure of the tubular conduit along the length of the tubular conduit to cause the pesticide to be discharged from the tubular conduit at a substantially uniform rate along the length of the tubular conduit and form a chemical barrier against the infestation of pests into the structure through openings formed in the foundation of the structure. The device and method of Hoshall can also be adapted for the present invention, such that installed underground structures can be used to uniformly apply bio-derived surfactants to a specified region, such as a bed of plants, trees, or shrubs at risk to attack by pests.

For soil treatments, any known method of applying insecticides or other agents to soil may be contemplated within the scope of the present invention. Soil may be treated in the field, or pretreated before being delivered to an agricultural site. Soil preparation prior to application of the compounds of the present invention can include tilling-free mechanical treatment of soil, including cutting or slits or formation of holes, trenches, or other structures to allow for liquids or gases to more readily enter the soil.

Soil treatment may also be conducted in conjunction with covering materials such as plastic films over the ground. Film may be applied before or after application of the aqueous compounds of the present invention. For example, in one embodiment, a film may be applied to the soil, and then it may be push into the soil at spaced apart regions. The film may be pierced in those regions where it penetrates into the soil, and then the aqueous solution may be applied such that it enters the soil through the pierced covering in the regions where the covering has been pushed into the soil. In one example, a four-centimeter deep hole may be formed in the soil into which a liter or more of the aqueous solution is applied.

With or without films or other ground coverings present, application of the aqueous solution may be done at the base of an existing plant or in the locales where seeds have been or will be planted.

In one embodiment, the same apparatus used to inject methyl bromide into the soil can be used to inject aqueous solutions of the present invention, though the tank may have to be larger and suitable nozzles and control devices may be used for liquid rather than gas. But the principle of injecting the pesticide into the soil and automatically applying a covering material would be used.

When coverings are used, any known ground covering such as Visqueene polyethylene film (British Polythene Limited, London, England) may be used. Plastic films may be clear, black, etc. Other mechanical aids can include soil coverings such as impermeable or vapor permeable film or fabric coverings, layers of materials such as compost or manure, and the like. An example of a film for treatment of the soil is described in U.S. Pat. No. 5,846,661, “Film for the Treatment of Soils by Fumigation,” which may be used after or during treatment with the compounds of the present invention, or may be used for other treatments in combination with the methods of the present invention.

Other known treatments of soil or seeds may be performed in addition to or in combination with the methods of the present invention. Such treatments may be applied prior to, after, or during the implementation of the methods of the present invention. Exemplary other treatments include but are not limited to:
Solarization (e.g., exposure to sunlight under a transparent or translucent plastic film or nonwoven web, for example), such as the method described by R. Gonzalez-Torres, J. M. Meléro-Vara, J. Gómez-Vázquez, and R. M. Jiménez Diaz (1993), “The Effects of Soil Solarization and Soil Fumigation on Fusarium Wilt of Watermelon Grown in Plastic House in South-Eastern Spain,” Plant Pathology 42 (6), pp. 858-864 (doi:10.1111/j.1 365-3059.1993.tb02671.x).
Gaseous fumigant treatments, including conventional fumigants such as methyl bromide, phosphine and carbonyl sulphide, or mixtures such as the mixed gas of hydrogen phosphide and methyl bromide described in U.S. Pat. No. 5,353,544, “Fumigation Apparatus.” Other fumigant mixtures include the cyanogen treatments described in U.S. Pat. No. 6,001,383, “Cyanogen Fumigants and Methods of Fumigation Using Cyanogen” or US 20070077311, “Fumigant/Sterilant,” which describes cyanogen and carbon dioxide used together as a soil treatment, with the cyanogen concentration below its flammability limit.
Treatments with methyl iodide, sodium metam, dazitol, sodium azide, allyl isothiocyanate, ethylene dibromide, telone or any other known or proposed alternative to methyl bromide.
Composting or application of green manure (adding green plant growth into the soil).

### Combination with Carbon Dioxide

In some embodiments of the present invention, the aqueous solution can be combined with carbon dioxide. For example, the water may be carbonated prior to, after, or during mixing of the water with the bio-derived surfactant, and the resulting solution may be carbonated sufficiently to provide generation of bubbles at nucleation sites, or to at least comprise carbonic acid or reaction products of carbonic acid, such that the solution can deliver additional carbon to the crops obtained from the provided carbon dioxide. In some embodiments, the application of significant amounts of carbon dioxide to the bio-derived surfactant solution or into the soil in the presence of a bio-derived surfactant can be used to help sequester carbon dioxide and potentially be a tool to reduce greenhouse gas concentrations in the atmosphere.

In testing the combination of carbon dioxide with the bio-derived surfactants of the present invention, it has been observed that carbon dioxide may have synergistic effects with the bio-derived surfactants. For example, it has been observed that carbon dioxide can anesthetize many insects, including larvae of root weevils as well as nematodes.

Without wishing to be bound by theory, it is possible that the effect of carbon dioxide may enhance the effectiveness of the bio-derived surfactant solution by at least temporarily decreasing any coping mechanisms the targeted pests might have in response to the presence of the surfactant, such as reducing the ability to flee to areas of lower surfactant concentration. For example, in treating nematodes, carbon dioxide may provide for immobility of the nematodes while the surfactant breaks the surface tension of the fluid surrounding its exterior sheath, allowing the nematode to drown or to be exsheathed. Modification of the physical interaction with the soil or modification of the pH may also play a role in delivering some benefits. The ability of carbon dioxide to stimulate root growth and plant growth in general may also contribute to a beneficial effect on plants treated with carbon dioxide in combination with a bio-derived surfactant. The ability of the surfactant to improve penetration of a solution into the soil may also play a positive role in enhancing carbon dioxide sequestration and biological uptake. The role of carbon dioxide on other organisms in the soil can also be a consideration when to use carbon dioxide most effectively.

The aqueous solution, combined with carbon dioxide, may be applied to soil or plants by every method already described. In some embodiments, carbon dioxide may be used to atomize a treatment solution and apply it to the ground or to above-ground plant structures, resulting in further delivery of carbon dioxide that can be available for uptake by plants. Users of the invention should note that a sub-surface delivery of the solution results in carbon dioxide evolving less rapidly than in an open air delivery.

### EXAMPLES

### Example 1

Larvae and pupae of the root weevil, Diaprepes abbreviatus, were immersed in a variety of compounds to understand their effect on the activity of this pest. In the tests, the Soy Technologies Manufacturer's Base proved to be effective in rendering the larvae moribund without necessarily killing them. Indeed, the mortality rate for Manufacturer's Base was not greater than the control treatment of tap water or carbonated water.

The criterion for toxicity with these larvae is the lack of nipping behavior and its consequent black residue from blood loss and the lack of spontaneous movement. Compounds and formulations that were toxic nevertheless generated unexpectedly low mortality with time, but rather displayed a moribund effect that appeared to be permanent, which was an unexpected and surprising result The moribund effect can be likened to the toxicity delivered by a wasp in stinging its prey: the prey lives on but does not feed or move. Pupae also did not move after treatment with the toxic materials identified in this series of test, but were difficult to assess with this design and were not tested further.

Experimental Design. Larvae and pupae were received from the Florida Dept. of Agriculture's rearing program in Gainesville, Fla. Larvae were shipped as 50-day larvae (larvae that will pupate in about 10 days). Both larvae and pupae were held at 27° C. in 12 hour cycles of light and dark in their containers as separate individuals until experimentation began.

Materials for testing were obtained from Sigma-Aldrich. These materials include polyoxyethylene 10 tridecylether (CAS #24938-91-8), ethoxylated castor oil (CAS #61791-12-6, Cremophor, from BASF), dimethylglutarate (CAS #1119-40-0, Fluka, 97% purity), dimethylsuccinate (CAS #106-65-0, Fluka, 98%), dimethyladipate (CAS #727-930 from DuPont), SuperWet 7-057 and Tomadol 1-7 from Anderson Chemical (Litchfield, Minn.), SuperSolve, SC-1000, and SuperCon from GemTek Products (Phoenix, Ariz.), SoyFast Manufacturer's Base from Soy Technologies (Nicholasville, Ky.), and Pel-Soy 676 ethoxylated soybean oil from Pelron Corp. (Lyons, Ill.), a soy ethoxylated soy methyl ester amid (CAS #6842544-5).

In the testing, five larvae or pupae were removed from their rearing cups and placed in a 150 ml glass beaker. In testing the Soy Technologies Manufacturer's Base (SMTB), a 5% solution was mixed in either water or carbonated water by adding 10 ml of SMTB to a 250 ml beaker and then adding water or carbonated water to the 200 ml mark. The solutions were then immediately added to the beaker with the larvae or pupae to cover them. Controls with water or carbonated water alone were also included. There was a single tray of five larvae for each treatment at each time period and a five larvae control for each time period. Larvae were removed and placed on plastic weighing trays after 5, 10, 15, 20, 25, and 30 minutes. At the end of 30 minutes all organisms were assessed for mortality. Trays with larvae were left on the bench tip for 24 hours and then another mortality assessment was made.

Observations. Water controls remained active throughout the 30-minute period and were alive and active when placed in their weighing trays. The larvae treated with 5% Manufacturer's Base were active until about 10 minutes. Larvae became moribund after about 10 minutes. Treated larvae remained inactive for at least one hour after treatment. All treated larvae moved when probed with a sharp probe and were alive at 30 minutes.

Pupae. This insect has a pharate pupa; that is, a pupa that resembles the adult beetle. These pupae move, but they did not move upon probing with a sharp probe and thus proved not useful for this evaluation. There was movement in all trays at 24 hours for the water treatment; there was no movement in the SMTB treatments. For the carbonated water treatment, there was no movement in any Manufacturer's Base treatment at 24 hours. For pupae treated with carbonated water only, there was movement in every tray. The adults in the 5, 10, and 30 minute treatments were alive.

Larvae. At 24 hours the untreated and water controls were active and were nipping at one another. This is a known cannibalistic behavior by the larvae of this species. As a consequence the trays were covered with black blood, the normal color of insect blood when exposed to air. There was movement in all control trays, but not all larvae were moving. The treated larvae were all moribund with no movement in any tray. The untreated controls were all alive at 24 hours.

TABLE 1
Larval mortality 24 hours after from 5% STMB
treatment with time.

Minutes

| | Untreated | 5 | 10 | 15 | 20 | 25 | 30 |
|---|---|---|---|---|---|---|---|
| Water | 0 | 0 | 2 | 0 | 0 | 0 | 0 |
| STMB | 0 | 0 | 0 | 0 | 0 | 0 | 0 |

STMB = Soy Tech Manufacturers Base

Cannibalistic behavior leads to dirty larvae and a black residue. This indicates healthy larvae. Lack of a black residue and clean larvae signal moribund and sick larvae. The untreated and water controls were discarded as these larvae were in no condition for an assessment for an additional 24 hours. The treated larvae were left on the bench top for an additional 24 hours. The results for Manufacturer's Base in carbonated water were the same as for SMTB in water. Treated larvae were moribund and clean except for the untreated control. Carbonated water controls were dirty with a black residue in each tray, i.e., healthy with normal behavior After 48 hours these larvae were generally alive (Table 2) and moribund.

TABLE 2
Mortality of larvae with 5% STMB in
carbonated water with time.

| | | Minutes | | | | | |
|---|---|---|---|---|---|---|---|
| | Untreated | 5 | 10 | 15 | 20 | 25 | 30 |
| 24 hours | 3 | 1 | 0 | 1 | 0 | 1 | 1 |
| Carbonated water | | | | | | | |
| STMB in | 3 | 0 | 1 | 2 | 0 | 1 | 0 |
| Carbonated Water | | | | | | | |
| 48 hours* | — | 1 | 2 | 2 | 1 | 2 | 1 |

*Carbonated water controls discarded after 24 hours.

Concentration Series. With the results from the time series above, larvae were held in different concentrations of STMB for 30 minutes. After 30 minutes, solutions were poured off and the trays wiped dry. Assessments were made at 24 or 48 hours with a few assessments at 72 hours dependent on effects. Treatments were: water or carbonated water as controls, and 0.1, 0.5, 1.0, 2.0, 3.0, 4.0 and 5.0% concentrations in either distilled water or carbonated water. Five larvae were used for each control and treatment. Pupae were not used in this assessment.

TABLE 3
Mortality with STMB and concentration.

| Time | | % Concentrations | | | | | | |
|---|---|---|---|---|---|---|---|---|
| period | Untreated | 0.1 | 0.5 | 1.0 | 2.0 | 3.0 | 4.0 | 5.0 |
| 24 hours | 0 | 2 | 0 | 2 | 0 | 0 | 1 | 1 |
| 48 hours | 3 | 2 | 1 | 2 | 3 | 0 | 3 | 2 |
| 72 hours | 4 | 3 | 2 | 2 | 5 | 2 | 4 | 5 |
| 96 hours | 4 | 3 | 2 | 3 | 5 | 2 | 4 | 5 |

Results are shown in Table 3 above. At 48 hours 0.1 ml of water was added to each tray to prevent desiccation. At 48 hours the water controls were in very poor shape due to nipping. The 0.1% treatment looked about like the water controls at 48 hours. Overall, for treatments 0.5% and up the larvae died from the treatment. The water and 0.1% treatments died from blood loss as evidenced by the black residue in those trays.

The use of carbonated water appeared not to increase the efficacy of this treatment. After 48 hours, there appeared to be no difference between 5% STMB in water and 5% STMB in carbonated water. Based on these data, only larvae were used and the assessment of compounds was made with water or carbonated water controls, 0.1, 1.0, 0.3, and 5.0% concentrations. In general, 48 hours should be enough for this assessment. Lack of toxicity or high toxicity should show in the first 24 hours.

For compounds that mimic STMB with clean and moribund larvae, this assessment will be extended to 72 hours.

Other Compounds: Ethoxylated castor oil (CAS #61791-12-6). After 24 hours, the control and 0.1% treatment looked the same. 1.0 and 3.0% treatments have less blood residue than the control and 0.1%. The 5.0% treatment larvae were moribund. At 48 hours, it is obvious that the dead were from nipping. The 5.0% treatment resulted in larvae that were clean, moribund and obviously sick. The 5.0% larvae were set together in a covered cup, to assess for mortality. The other treatments were discarded at 48 hours. At 72 hours, there was still only one dead, all larvae were clean and moribund.

Dimethyladipate (a.k.a. Adipic Acid, Dimethyl Ester or Dimethyl hexanedioate, CAS #727-930). Preparations of 1.0, 3.0, and 5.0% concentration were not completely soluble. The solutions were poured off the top for treatment. The 0.1% preparation was soluble. The 3 and 5% solutions attacked the plastic. This is a rather noxious compound and not recommended for use. At 24 hours the control and 0.1% looked identical and not much different from the 1.0 and 3.0% treatments The 5.0% treatment contained only slightly less black residue than the 3.0% treatment. This compound was judged non-toxic to specimens and the test was terminated at 24 hours.

Results for the tested compounds, showing CAS numbers when available, are presented in Table 4.

TABLE 4
Mortality of larvae with individual compounds
and formulations.

| | | Concentration percent | | | | |
|---|---|---|---|---|---|---|
| Compound | Time | Control | 0.1 | 1.0 | 3.0 | 5.0 |
| 61791-12-6 | 24 hours | 0 | 0 | 1 | 2 | 1 |
| | 48 hours | 0 | 0 | 3 | 3 | 1 |
| | 72 hours | — | — | — | — | — |
| Pel-Soy 676 | 24 hours | 1 | 2 | 0 | 1 | 0 |
| | 48 hours | 2 | 3 | 1 | 1 | 0 |
| | 72 hours | 3 | 3 | 1 | 3 | 0 |
| | 120 hours | 5 | 5 | 3 | 3 | 1 |
| 106-65-0 | 24 hours | 0 | 2 | 2 | 1 | 1 |
| 627-93-0 | 24 hours | 1 | 2 | 1 | 2 | 3 |
| 24938-91-8 | 24 hours | 0 | 0 | 2 | 0 | 0 |
| | 48 hours | 0 | 0 | 2 | 0 | 3 |
| | 72 hours | 0 | 0 | 2 | 0 | 3 |
| SC-1000 | 24 hours | 0 | 0 | 2 | 0 | 0 |
| Tomadol 1-7 | 48 hours | 1 | 0 | 0 | 1 | 2 |
| | 72 hours | 2 | 0 | 1 | 2 | 1 |
| 1119-40-0 | 48 hours | 2 | 3 | 1 | 0 | 1 |
| | 72 hours | 4 | 3 | 2 | 0 | 2 |
| Supersolve | 48 hours | 1 | 1 | 2 | 3 | 2 |
| | 72 hours | 1 | 2 | 5 | 3 | 2 |

After 30 minutes, all larvae were alive in all tests.

Polyoxyethylene 10 tridecylether (a.k.a. polyoxyethylene tridecyl alcohol, tridecyl alcohol ethoxylate, with structure C₁₃H₂₇(OCH₂CH₂)ₙOH, CAS# 24938-91-8). At 24 hours there was a gradation of black residue from control to 5.0 with 5.0 having the least. At 48 hours all treatments had black residue. The control, 0.1 and 1.0% were the same with 3 and 5 having less black residue and equal to one another.

SC-1000. At 24 hours all trays appeared equal in black residue. Larvae were active. This formulation is judged to be non-toxic to these larvae. This test was terminated at 24 hours.

Pel-Soy 676. The 3.0 and 5.0% treatments were fairly viscous solutions. The 1.0 and 0.1% solutions mixed easily. The 3 and 5% solutions are syrupy. At 24 hours the 3.0 and 5.0% treatments were moribund with clean trays. The control had presented the blackest residue, then 0.1, then 1.0. At 48 hours 3.0 and 5.0 were fairly clean. The control and 0.1 look the same with 1.0 in between. At 96 hours there was a gradation of black residue from control to 5.0 with 5.0 being the least.

The toxicity in 1.0, 3.0, and 5.0% treatments resemble STMB toxicity.

Dimethyl succinate (a.k.a. butanedioic acid, dimethyl ester CAS# 106-65-0). The 3% and 5% concentrations were not soluble while the 1.0% appears to be just soluble. The 0.1% was soluble. This treatment was terminated after 24 hours as all treatments looked just like the control. This compound was judged to be non-toxic to these larvae.

Tomadol 1-7 (an alcohol ethoxylate made from linear Cl1 alcohol with 7 moles average of ethylene oxide and an HLB of 12.9) All larvae were alive after 30 minutes. The 5% solution is on the cusp of solubility. At 48 hours the 1, 3, and 5% treatments had less black residue compared to the control and 0.1%.

Dimethylglutarate (a.k.a. pentanedioic acid, dimethyl ester, CAS #1119-40-0). All larvae were alive after 30 minutes The 1, 3, and 5% solutions were not completely soluble. At 48 hours the 3 and 5% treatments have less black residue than the control and 0.1 and 1.0% which appear to be equal in black residue.

Supersolve (from GemTek Products, Phoenix, Ariz., believed to contain bio-derived surfactants obtained from fatty acids). All treated larvae were alive and moribund at 30 minutes. The water controls were alive and active after 30 minutes. The 3 and 5% solutions were cloudy and yellow. The 3 and 5% treatment larvae defecated, the first time this happened in these tests. At 48 hours there was less black residue in the 3 and 5% treatments. The control, 0.1, and 1.0% treatments appeared to have equal amounts of black residue.

### Example 2

Nematicidal properties of a compound within the scope of the present invention were explored with the assistance of Radewald Research & Diagnostics (Moreno Valley, Calif.). One hundred pots were each filled with 500 grams of soil that was infested with root knot nematodes. The pots were apportioned among ten different test series. In each test series, nine pots were drenched with 150 ml of SoyFast™ Manufacturer's Base marketed by Soy Technologies (Nicholasville, Kentucky) with concentrations that ranged from 0.1% to 10% and a tenth pot was drenched with 150 ml of tap water alone. The drench volume was adequate to saturate the pot and result in some runoff.

For each level of treatment, five pots were sampled for nematodes 72 hours after treatment, and five additional pots were samples 120 hours after treatment. Results are shown in Table 5 below, with numbers indicating the actual number of root knot nematodes counted per 500 gm of soil. Each 500 gm portion of root knot infested soil was processed via the wet screen Baerman technique.

TABLE 5
Treatments for Root Knot Nematodes

| | | | | 3 days + |
|---|---|---|---|---|
| Treatment | Concentration | 3 days | 5 days | 5 days |
| 1 | 0.1% | 2540 | 2860 | 5400 |
| 2 | .5% | 1820 | 2490 | 4310 |
| 3 | 1% | 1900 | 1710 | 3610 |
| 4 | 2% | 912 | 1392 | 2304 |
| 5 | 3% | 300 | 356 | 656 |
| 6 | 4% | 232 | 712 | 944 |
| 7 | 5% | 160 | 368 | 528 |
| 8 | 7.5% | 82 | 286 | 368 |
| 9 | 10% | 122 | 76 | 198 |
| 10 | 0% | 2120 | 1430 | 3550 |

The results show significant decreases in nematode populations for concentrations of about 2% and higher.

### Example 3

To test the effectiveness of a bio-derived surfactant against citrus nematodes, citrus nematode (Tylenchulus semipenetrans) infested soil was taken from a citrus field, well mixed and screened for large debris and potted in 500 ml plastic containers with drainage holes. The infested soil was near field capacity, loamy sand with a stable organic content of about 1.0% . Air temperature of between 75-82° F. was maintained for this trial. One hundred pots were filled with the infested soil. Ten were drenched with 100 ml of each of the nine (9) concentrations of the SoyFast™ Manufacturer's Base marketed by Soy Technologies (Nicholasville, Ky.) with concentrations that ranged from 0.1% to 10%, and a tenth pot was drenched with 100 ml of tap water alone. The 100 ml drench per pot was adequate to saturate the soil and provide some runoff.

Five pots of all treatments were sampled for nematodes 72 hours after treatment and five after 120 hours. Results are presented in Table 6. Numbers in the tables represent the actual number of citrus nematodes per 50 ml of soil. The soil (50 ml) was taken randomly from each pot after mixing the pot contents (500 ml) and processed with the soil Baerman technique. Samples were on the funnels for processing for 72 hours.

TABLE 6
Treatments for Citrus Nematodes

| | | | | 3 days + |
|---|---|---|---|---|
| Treatment | Concentration | 3 days | 5 days | 5 days |
| 1 | 0.1% | 2650 | 2205 | 4855 |
| 2 | 0.5% | 1750 | 1020 | 2770 |
| 3 | 1% | 294 | 736 | 1030 |
| 4 | 2% | 144 | 268 | 412 |
| 5 | 3% | 6 | 26 | 32 |
| 6 | 4% | 0 | 5 | 5 |
| 7 | 5% | 0 | 14 | 14 |
| 8 | 7.5% | 1 | 0 | 1 |
| 9 | 10% | 0 | 1 | 1 |
| 10 | 0% | 2320 | 2352 | 4672 |

The results show significant decreases in nematode populations for concentrations of about 1% and higher.

### Example 4

SC-1000, a product of GemTek Products (Phoenix, Ariz.) comprising bio-derived surfactants, was applied in an aqueous solution via an irrigation system to the grass on a lawn, with the observation that the regions treated grew better than untreated regions. The observations suggest that not only is the composition not harmful to the grass, but stimulated growth. Without wishing to be bound by theory, it is believed that the improved penetration of the surfactant solution into the soil, due at least in part to decreased surface tension, allowed water to be better retained in the soil and used by the plant.

### Example 5

The impact of the bio-derived surfactant on solution penetration into the soil was explored by visual examination of wetting experiments conducted for a Florida sandy soil (Candler Fine Sand) between two parallel glass plates. Experiments were designed to determine if there is a difference between the infiltration of carbonated, non-carbonated water, carbonated surfactant solutions and non-carbonated surfactant solutions in Candler Fine Sand. The control treatments are water and carbonated water. The experimental treatments are 1, 3, and 5% surfactant solutions of Soytech Manufacturers' Base, SC-1000 and Super Wet (Anderson Chemicals). In tests of liquid penetration into the sand, followed by examination of the wetted cross-sections of soil, it was observed that control treatments usually result in a broad wetted area at the top of the soil column (at the air interface) that becomes more narrow with depth. But the presence of surfactant and/or carbonation resulted in a profile that became wider with depth.

While water poured onto a region of the soil showed a wetting profile that resembled the letter “V”—wide at the upper surface and narrower in cross-section away from the surface, the solution with about 3% bio-derived surfactant (SC-1000 of GemTek Products) showed the opposite trend: the wetted region tended to grow laterally as the fluid moved downward, resulting in a wetted cross-sectional profile more like a trapezoid with a broad base and narrow top, rather than like the “V” seen with plain tap water. Without wishing to be bound by theory, it is believed that the reduced surface tension in the bio-derived surfactant solution allows water to penetrate into the air-filled and sometimes hydrophobic pores of the soil more readily and produces enhanced lateral wicking. Whatever the cause of the observed behavior, the ability of the bio-derived surfactant solutions of the present invention to spread laterally suggests that application at the top of a plant by pouring or otherwise applying the solution may be sufficient to reach much of the soil in contact with the roots, especially in cases where the roots are broad in lateral scope. The implication is that the application of an aqueous solution applied at a single spot at the base of a plant is more likely to spread out laterally lower in the soil and thus more likely to treat a root ball or laterally spread roots when the surfactant is present, or when carbonation is present, or both.

### Example 6

pH effects were explored with SC-1000. When diluted in a 1:3 ratio with water, a solution of SC-1000 had a pH of about 11. The same solution, when exposed to pressurized carbon dioxide to become slightly carbonated, had a pH of about 9. Neutralization of the pH of alkaline bio-derived surfactants with carbon dioxide is within the scope of the present invention and may be used for suitable applications.

### Example 7

Tests with SC-1000 were conducted to examine the effect on germination of morning glory seeds, a troublesome weed in many parts of the United States. In a greenhouse test, 400 seeds were planted, with 100 for each of four trials. Trials conducted included treatment with SC-1000 (GemTek), Manufacturer's Base by Soy Technologies, SuperWet (Anderson Chemical), and tap water as the control. Candler Fine Sand was used, which is a well-known soil in Florida with about 1% organic matter. Testing involved drenching with solutions of various concentrations of the applied compounds: 5%, 4, 3, 2, and 1%. For each applied concentration, the number of plants that germinated was counted, with counts conducted weekly for three weeks. The tests showed that concentrations above 1% were effective in stopping or substantially delaying germination of the morning glory seeds.

A related test was conducted with tomato and pepper seeds in the same tray where the weed seeds were. The results showed that weed germination was prevented for applied concentrations above 1%, whereas the tomatoes and peppers could still germinate, though germination may have been delayed.

### Example 8

Phytotoxicity was explored by applying SC-1000 at various concentrations to living plants in a drench applied at the base of the plant, In general, it has been observed that at high concentrations such as at 5% or higher, plants are damaged or killed, whereas little harm is seem for lower concentrations. For concentrations that do not appear to injure the plant right away, an examination of plant height change over a 3 week period showed no difference in plant growth relative to the controls.

The relatively low phytoxicity of SC-1000 and its effectiveness in hindering weed germination and growth suggests that bio-derived surfactants may be useful in controlling weeds without damaging the crops themselves. This is an important observation because it suggests that in addition or instead of soil treatment prior to planting, the compounds of the present invention may be applied directly to post-emergent crops in the areas where pests are a problem. The ability to spot-treat crops as pests emerge may allow for much more efficient use of pesticides (application only where needed, resulting in lower costs, less waste and reduced environmental impact).

Spot treatment of existing crops cannot be done with methyl bromide or with most proposed replacements because the plant would be killed or injured. Thus spot treatments during the growing season are generally not feasible with conventional soil pesticides. For example, when a citrus grove or grape vineyard is infected with root weevil (diaprepes), spot treatment with methyl bromide is not possible without harming the plant.

### Example 9

SoyFast™ Manufacturer's Base marketed by Soy Technologies (Nicholasville, Ky.) was applied to soil in a carbonated aqueous solution to demonstrate the ability to add carbon dioxide with a potentially insecticidal/herbicidal/nematicidal treatment. A tank of pressurized carbon dioxide was used as the CO₂ source. Applied CO₂ pressure was controlled with a regulator and flow rates were measured with an electronic flow meter. A peristaltic pump delivered the aqueous solution of Manufacturer's Base into a flow line running to a buried horizontal tube of 6-inch diameter PVC tubing, about 1 meter in length, sealed at both ends with 1/16-inch holes drilled along the lower surface of the tubing to allow internal fluid (e.g., liquid and CO₂) to enter the soil. The lower surface of the tubing was buried 18-inches below the surface. CO₂ and the liquid solution were combined together with a curved-T fitting and directed via a hose into the buried PVC tube, where the liquid and CO₂ entered the soil.

### Example 10

An experiment with bell peppers on Florida farm land demonstrated improved yields using a bio-derived pesticidal treatment. Aqueous solutions comprising 5% SC-1000 (GemTek Products, Phoenix, Arizona) were applied preplant from a Ag Sprayer (water wagon) at a rate of approximately 15 gallons of liquor per acre. Approximately 2 acres were treated 2 weeks prior to plant under plastic similar to typical procedures using Methyl Bromide 6733. Another 2 acres was applied immediately prior to plastic application and planting. Another 1 acre had the solution topically applied to the soil through soaker hoses at the base of the plants after they were placed in the soil without the application of plastic. Observations suggested that the treated soil and treated plants allowed the peppers to thrive, with no evidence of phytotoxicity.

Throughout the growing process, plants were monitored weekly, and in general appeared to be grow taller and more densely than the plants in soil that had been treated with methyl bromide. The final yield of the plants grown in soil treated with SC-1000 was estimated to be about 20% greater than those raised in soil treated with methyl bromide.

### Example 11

The SC-1000 product of GemTek Products (Phoenix, Ariz.) was used to treat lime seedlings in a greenhouse environment to examine harm to the plants. Plants were irrigated with aqueous dilutions of the mixture, up to a concentration of 5% SC-1000. Observations of the seedlings up to 14 days after exposure indicated no detectable harm. Thus, it appears that the bio-derived surfactant composition may be able to be used directly on some young plants without obvious harm.

### Example 12

Tests were conducted to determine the effect of STMB on the germination of weed and vegetable seeds with the specific goal of determining the lowest effective concentration for weed seeds and the residual effect on vegetable seeds. Specifically, products were tested for their ability to inhibit tomato, pepper, and weed seed germination. Five percent STMB inhibited the germination of Johnson grass, ivy leaf, and pigweed with SuperWet and SC-1000 having a lesser effect. This pre-emergence herbicide activity lasted about three weeks after treatment. STMB, SC-1000 3× and SuperSolve might serve as pre-emergence herbicides based on these tests.

Testing was conducted in a greenhouse at day/night temperatures of 25/16° C. (±0.5° C.), 70% (±5%) relative humidity and ambient light. The greenhouse reduced photosynthetically active radiation to a maximum of 1200 pmol/m2/s at midday. Herbicidal activity towards the germination of three weed seeds common in central Florida—Ivy leaf morning glory (Ipomoea hederacea), pigweed (Amaranthus retroflexus) and Johnson grass (Sorghum helepense), was examined.

Metal trays were filled with soil collected from the field from 0 to 15 cm from a site where herbicides have not been used for more than 15 years. The soil was saturated with water and allowed to dry overnight to bring soil moisture to field capacity. One hundred seeds of each species were sown in two rows.

After concluding a three replicate preliminary study on the effect of a 5% concentration of Cleareso products in water or carbonated water on the germination of weed seeds (Tables 7 and 8), this study was continued with 4%, 3%, 2%, and 1 % of SoyTech Manufacturers Base (STMB), SC-1000, SuperWet, Super Solvent, and SC-1000 3x concentration. Treatment solutions were prepared in tap water and 1000 ml of solution equivalent to 0.25″ rainfall were applied to each tray to saturate the soil in the tray. Seeds were allowed to germinate for one week and seedlings were counted. This study was repeated once.

Residual Effects on the Germination of Vegetable Seeds. The residual effect of the products on germination of tomato and pepper seeds was observed each week for three weeks. After recording the germination percentage one week after treatment, weed seedlings were removed and seeds of tomato and green pepper were sown in the trays in rows separate from the original plantings. The germination of tomato and green pepper seeds was recorded a week after this sowing. Germinated seedlings were again removed. Additional seeds were sown in a different area of the same tray and seven days later vegetable seedlings were counted and removed. Vegetable seeds were sown a third time and again the number of germinating seeds was recorded after 7 days.

Germination of Weed Seeds: 5% Concentration (Tables 7 and 8). It was clear from the data that all the seeds germinated in the water and carbonated water treatment controls (Table 7). A slight and statistically insignificant effect was observed on the germination of pigweed and Johnson grass in carbonated water. There was no effect of carbonated water on the germination of ivy leaf morning glory. For carbonated water, germination was different from controls with all three species with 5% STMB (Table 7) and for 5% SW with ivy leaf and pigweed.

For materials prepared in water, 5% STMB inhibited the germination of all species (Table 8). SC-1000 inhibited the germination of Johnson grass and pigweed; SW inhibited pigweed (Table 8).

This preliminary study showed that these products, particularly STMB, have the potential for completely inhibiting the germination of weed seeds.

Residual effect on Pepper and tomato seed germination (Table 9). Tomato variety “Striped Stuffer” and pepper variety “Chinese Giant Sweet” seeds were planted in the trays one week after treatment. After one week there was no germination of either pepper or tomato seeds in STMB treated trays (Table 9). This observation held true for seeds sown at 2 and 3 weeks after treatment. There was no germination of tomato seeds for 2 weeks after STMB.

The intent of this experiment was to determine if waiting to plant a crop would ameliorate the effect of a treatment. For example, crops are planted three weeks after a methyl bromide treatment so there is minimal effect on the crop. It appears from Table 9 that although there are no statistically significant difference, it appears that there is a reduction in germination at 3 weeks, particularly for pepper (Table 9). That is, either the dose must be less than 5% STMB or more than three weeks must pass before planting a crop.

TABLE 7
Five percent concentration tests products and
the germination of weed seeds when prepared in
carbonated water.

| | Percent germination | | |
|---|---|---|---|
| | Johnson | Ivy leaf | |
| Treatment | grass | (morning glory) | Pigweed |
| Water | 100 ± 0 a | 100 ± 0 a | 100 ± 0 a |
| Carbonated | 94 ± 2 a | 95 ± 7 a | 85 ± 14 ab |
| Water | | | |
| 5% STM13 | 2 ± 3 b | 1^{±1} c | 0 ± 0 b |
| 5% SC- | 48 ± 32 ab | 86 ± 25 ab | 53 ± 45 ab |
| 1000 | | | |
| 5% SW | 40 ± 14 ab | 41 ± 27 bc | 0 ± 0 b |

Means in the same column are not statistically different using ANOVA followed by Tukey's HSD test, a = 0.05, n = 3.

TABLE 8
Five percent concentration tests and the
germination of weed seeds when prepared in water.

| | Percent germination | | |
|---|---|---|---|
| | | Ivy leaf | |
| | Johnson | (morning | |
| Treatment | grass | glory) | Pigweed |
| Water | 87 ± 19 a | 96 ± 6 a | 88 ± 17 a |
| 5% STM13 | 8 ± 2 b | 0 ± 0 b | 0 ± 0 c |
| 5% SC-1000 | 28 ± 8 b | 78 ± 5 a | 43 ± 8 b |
| 5% SW | 51 ± 11 ab | 81 ± 5 a | 12 ± 2 bc |

Means within the same column are not statistically different using ANOVA followed by Tukey's HSD test, a = 0.05, n = 3.

TABLE 9
Residual effect of Cleareso products on vegetable seed germination (%).

| | 1 week post | | 2 weeks post | | 3 weeks post | |
|---|---|---|---|---|---|---|
| | treatment | | treatment | | treatment | |
| Treatment | tomato | pepper | tomato | pepper | tomato | pepper |
| Water | 91 ± 4a | 0 ± 0a | 91 ± 8a | 78 ± 10a | 64 ± 56a | 60 ± 52a |
| Carbonated Water | 95 ± 2a | 0 ± 0a | 86 ± 19a | 73 ± 19a | 87 ± 19a | 57 ± 42a |
| 5% STMB | 0 ± 0b | 0 ± 0a | 0 ± 0b | 9 ± 15b | 18 ± 31a | 7 ± 12a |
| 5% SC-1000 | 87 ± 7a | 0 ± 0a | 89 ± 19a | 64 ± 25a | 51 ± 47a | 40 ± 34a |
| SW 5% | 85 ± 7a | 0 ± 0a | 95 ± 4a | 64 ± 21a | 64 ± 56a | 29 ± 30a |

Means within the same column followed by the same letter are not different by GLM followed by Tukey's HSD test, a= 0.05

Concentration and weed seed germination (Table 10). Table 10 data are the result of only two replications and statistical analyses are not possible. In Table 10 are trends in data. If a treatment inhibited germination then a lower concentration should result in higher germination. For Johnson grass, a lower concentration of all products resulted in greater germination except for SuperWet (Table 10). For ivy leaf morning glory a lower concentration resulted in greater germination for every product (Table 10). Based on higher germination compared to the other products, SuperWet and SC-1000 would not be useful as pre-emergence herbicides. STMB, SuperSolve, and SC-1000 3× might all serve as pre-emergence herbicides at concentrations above 2% for any of these weed species (Table 10).

TABLE 10
Percent germination with concentration in water.

| | Johnson | Ivy leaf | |
|---|---|---|---|
| Treatment | grass | morning glory | Pigweed |
| Water | 66 ± 7 | 92 ± 2 | 65 ± 6 |
| 4% STMB | 2 ± 2 | 1 ± 0 | 2 ± 2 |
| 3% STMB | 3 ± 2 | 2 ± 1 | 2 ± 3 |
| 2% STMB | 14 ± 6 | 11 ± 4 | 5 ± 7 |
| 1% STMB | 25 ± 9 | 36 ± 13 | 16 ± 22 |
| 4% SuperWet | 61 ± 6 | 35 ± 10 | 42 ± 22 |
| 3% SuperWet | 68 ± 1 | 71 ± 8 | 49 ± 29 |
| 2% SuperWet | 65 ± 4 | 75 ± 11 | 56 ± 18 |
| 1% SuperWet | 67 ± 1 | 88 ± 10 | 64 ± 6 |
| 4% SC-1000 | 39 ± 4 | 43 ± 6 | 34 ± 3 |
| 3% SC-1000 | 45 ± 13 | 60 ± 16 | 39 ± 5 |
| 2% SC-1000 | 55 ± 6 | 85 ± 13 | 53 ± 3 |
| 3% SC-1000 | 66 ± 8 | 92 ± 1 | 63 ± 4 |
| 4% | 1 ± 1 | 0 ± 0 | 0 ± 0 |
| SuperSolve | | | |
| 3% | 1^{±1} | 13 ± 0 | 3 ± 0 |
| SuperSolve | | | |
| 2% | 2 ± 1 | 23 ± 13 | 3 ± 0 |
| SuperSolve | | | |
| 1% | 25 ± 7 | 67 ± 1 | 22 ± 2 |
| SuperSolve | | | |
| 4% SC-1000 | 0 ± 0 | 0 ± 0 | 0 ± 0 |
| 3X | | | |
| 3% SC-1000 | 2 ± 0 | 4 ± 0 | 8 ± 8 |
| 3X | | | |
| 2% SC-1000 | 10 ± 0 | 22 ± 1 | 19 ± 13 |
| 3X | | | |
| 1% SC-1000 | 20 ± 1 | 57 ± 1 | 28 ± 13 |
| 3X | | | |

N = 2, no statistical comparisons possible.

### Example 13

A series of tests were conducted to determine the speed and depth of soil penetration of aqueous solutions of bio-derived surfactants. The average depth of soil penetration of water was at least doubled with the surfactants presents.

Soil was collected from the top 0-15 cm of typical Central Florida, well-drained Candler fine sand. Soil pH was 5 to 6.5 depending on soil depth. Organic matter was 0.3%, and the bulk density of 1.56 g/cm3 determined gravimetrically for the soil profile. Percent sand, silt, and clay contents were 96.5, 2.0, and 1.5, respectively. Soil was air-dried for one week to obtain uniform compaction for penetration experiments.

The study was conducted using soil leaching columns made of polyvinyl chloride (PVC) pipe, 30 cm long and 10 cm inner diameter, cut into halves longitudinally. Silicone beads were placed at 7.25 cm intervals along the inner wall to prevent preferential flow of applied solution along the soil-column interface. The halves were resealed using adhesive tape (professional HVAC tape, Scotch brand) to form a column and the bottom end was fitted with a PVC cap 10 cm in height with a drainage hole. A nylon screen with Whatman #1 filter paper was placed at the bottom of the PVC cap and columns were packed from the 0-15 cm of the soil profile. The columns were secured upright on a wooden platform.

Treatment solutions of 1% and 5% of SoyTech Manufacturers Base (STMB, Soy Technologies, LLC, Nicholasville, Ky. 40356), SC-1000 (Gemtek Products, Phoenix, Ariz.), and SuperWet 7-057 (Anderson Chemical Co., Litchfield, Minn.) were freshly prepared in carbonated water and were applied in one application to the soil surface. Two control columns, water and carbonated water without adjuvant, were included. The top surface of each soil column was made as a plain uniform surface and the columns were leveled. Whatman No. 4 Filter paper was placed on the surface to ensure proper spread and uniform solution flow through the column. A known volume of the treatment solution was applied to the soil surface with a graduated cylinder after calculating the volume of a 1- or 2-acre inch equivalent. Penetration was measured 30 minutes after the treatment application. The depth of penetration was determined by observation and measurement of the “wet line” in dry soil. This experiment was repeated three times with one replication each time; the average of three replications is presented in the tables. The penetration of each solution to the soil surface was timed in seconds.

Penetration Depth. When a 1% solution of the tested chemicals was applied as a 1-acre inch equivalent, there was no difference between the chemicals in the depth of penetration (12.1 to 13.4 cm) of each solution (Table 11). With the 5% concentration, there was variation in the penetration depth; maximum penetration was achieved by 5% SC-1000 (19 cm) -followed by 5% STMB (16 cm), and 5% SuperWet (13 cm) (Table 11). Depth of penetration recorded for normal water was 8 cm and for carbonated water was 9 cm. However, for the 1-acre inch equivalent, there was no difference in depth of penetration between treatments or between treatments and controls (Table 11).

For the 2-acre inch equivalent, solutions were applied at the 1% concentration only. This application penetrated to almost complete soil depth in the one foot PVC column. The depth of penetration with 1% STMB and 1% SC-1000 was 25 cm, and with 1% SuperWet, 23 cm (Table 11). Depth of penetration recorded for normal water was 16.8 cm and for carbonated water 18 cm. There was no statistical difference in the depth of soil penetration between treatments or between treatments and the water and carbonated water controls.

Time of Penetration. When the 1-acre inch and 2-acre inch equivalent volumes of solution were applied, STMB took the maximum time for penetration to the soil surface -137 seconds (1 inch) and 291 seconds (2 inches), respectively.

With the 1-acre inch equivalent at the 5% concentration, the solutions reached the soil surface in the order: 1. SC-1000 1%, 2. SF 1%, 3. SW 1%, 4. SC-1000 5%, and 5. SW 5%. Water took the least time (39.3 seconds) while carbonated water took 68.3 seconds to leach from the soil surface (Table 11). There was no statistical difference in the penetration times for the 1-acre inch equivalent solutions at either the 1 or the 5% concentration (Table 11).

TABLE 11
Infiltration of solutions in Candler fine sand.

| | 1-acre inch equivalent rainfall | | 2-acre inch equivalent rainfall | |
|---|---|---|---|---|
| | Time of max. | Maximum | Time to max. | Maximum |
| Treatment | infiltration (sec) | infiltration (cm) | infiltration (sec) | infiltration (cm) |
| Water | 39 ± 6 a | 8 ± 2 a | 101 ± 7 c | 17 ± 8 a |
| Carbonated | 68 ± 15 a | 9 ± 1 a | 163 ± 25 bc | 18 ± 2 a |
| water | | | | |
| 1% STMB | 106 ± 42 a | 13 ± 4 a | 291 ± 18 a | 25 ± 0 a |
| 5% STMB | 137 ± 40 a | 16 ± 2 a | | |
| 1% SC-1000 | 124 ± 61 a | 13 ± 8 a | 245 ± 39 ab | 25 ± 0 a |
| 5% SC-1000 | 96 ± 24 a | 19 ± 2 a | | |
| 1% SW | 102 ± 28 a | 12 ± 8 a | 254 ± 92 ab | 23 ± 2 a |
| 5% SW | 85 ± 17 a | 13 ± 2 a | | |
| | F = 2.40 | F = 2.03 | F = 8.10 | F = 3.69 |
| | P = 0.0694 | P = 0.1136 | P = 0.0035 | P = 0.0429 |

Means followed by the same letter are not significantly different using ANOVA followed by Tukey's HSD test, a = 0.05, n = 3.
STMB = Soy Tech Manufacturers Base,
SW = SuperWet (Anderson).

### Example 14

Tests were conducted to examine the effect of different concentrations of surfactant solutions on the growth of established tomato and green pepper seedlings.

Tomato variety “Striped Stuffer” and pepper variety “Chinese Giant Sweet” seeds were sown in 72-hole plastic trays in Fafard Professional 4 Mix Formula (Conrad Fafard, Inc. Agawam, Mass.). At a height of 5.0-7.5 cm (2 to 3 inches, seedlings were transplanted into sand in 32 oz. Styrofoam® cups with drainage holes. The sand was collected from the 0 to 15 cm layer from a field where herbicides have not been used for more than 15 years. After transplanting, seedlings were allowed to establish for two weeks. The seedlings were maintained in a greenhouse at day/night temperatures of 25/16° C. (±0.5° C.), relative humidity at 70% (±5%), and ambient light. The greenhouse reduced photo-synthetically active radiation to a maximum of 1200 μmol/m2/s at midday. Seedlings were watered regularly and fertilized once with Tracite fertilizer (Helena Chemical Co., Collierville, Tenn.) containing 20-20-20 (N-P-K) and after 10 days were transplanted to promote optimum growth. Seedlings were treated when they were 7 to 10 cm tall.

Materials were obtained from Gemtek, Inc. (Phoenix, Ariz.) and Soy Technologies, LLC (Nicholasville, Ky.). Seedlings were drenched at the base with 100 mL solution of 4%, 3%, 2%, and 1% concentrations with water as the control. Treatment solutions were prepared just before application.

Plant height was recorded at 0, 1, 2, and 7 days after treatment (DAT). The percent increase in height was used for data analyses. Percent mortality was also recorded. Means were compared by ANOVA followed by Tukey's HSD test, □=0.05.

Plant height data of tomato and pepper seedlings are given in Tables 12 and 13. For controls, plant height increased 54% for tomatoes and 97% for green pepper.

SoyTech (STMB). Tomato plants were killed at the 1% concentration of STMB while pepper showed a 9% increase in plant height. Two to 4% STMB killed both tomato and pepper seedlings. Pepper plants were typically dead at the stem, but the leaves were still green in color. That is, pepper plants died from the bottom up.

TABLE 12
Average percent increase in plant height
after 7 days.

% Increase in height*

| Treatment | Tomato | Pepper |
|---|---|---|
| Water | 54 ± 4 a | 97 ± 21 a |
| 1% STMB | −2 ± 1 e | 9 ± 5 i |
| 2% STMB | −100 ± 0 f | −100 ± 0 i |
| 3% STMB | −100 ± 0 f | −100 ± 0 i |
| 4% STMB | −100 ± 0 f | −100 ± 0 i |
| 1% SC-1000 | 50 ± 3 ab | 77 ± 14 abcd |
| 2% SC-1000 | 42 ± 10 bc | 90 ± 20 ab |
| 3% SC-1000 | 32 ± 7 cd | 73 ± 19 abcde |
| 4% SC-1000 | 30 ± 3 d | 58 ± 14 bcdef |
| 1% SCC | 48 ± 4 ab | 67 ± 12 abcdef |
| 2% SCC | 1 ± 1 e | 34 ± 13 fgh |
| 3% SCC | 0 ± 0 e | 18 ± 6 gh |
| 4% SCC | −100 ± 0 f | 9 ± 14 h |
| 1% SS | 28 ± 3 d | 39 ± 3 efgh |
| 2% SS | −0.4 ± 3.0 e | −100 ± 0 i |
| 3% SS | −100 ± 0 f | −100 ± 0 i |
| 4% SS | −100 ± 0 f | −100 ± 0 i |
| 1% SW | 47 ± 2 ab | 61 ± 17 abcdef |
| 2% SW | 4 ± 4 e | 85 ± 20 abc |
| 3% SW | −3 ± 4 e | 50 ± 10 bcdef |
| 5% SW | −0.3 ± 5.0 e | 47 ± 3 defg |

*Mean ± standard deviation, n = 3. Means in the same column followed by the same letter are not different by ANOVA followed by Tukeys HSD □ = 0.05.
STMB = SoyTech,
SW = SuperWet,
SC-1000, SCC = SC-1000 3X,
SS = SuperSolve.

SC-1000. There was an increase of 50% in tomato plant height with 1% SC-1000 which was reduced to 30% to 4%. There was no difference in pepper plant height increase comparing 1-4% SC-1000, 77-58% (Table 12).

TABLE 13
Average percent increase in plant
height after 7 days with negative means removed.**

% Increase in height*

| Treatment | Tomato | Pepper |
|---|---|---|
| Water | 54 ± 4 a | 97 ± 21 a |
| 1% STMB | | 9 ± 5 e |
| 2% STMB | | |
| 3% STMB | | |
| 4% STMB | | |
| 1% SC- | 50 ± 3 a | 77 ± 14 abc |
| 1000 | | |
| 2% SC- | 42 ± 10 ab | 90 ± 20 ab |
| 1000 | | |
| 3% SC- | 32 ± 7 b | 73 ± 19 abc |
| 1000 | | |
| 4% SC- | 30 ± 3 b | 58 ± 14 abcd |
| 1000 | | |
| 1% SCC | 48 ± 4 a | 67 ± 12 abc |
| 2% SCC | 1 ± 1 c | 34 ± 13 cde |
| 3% SCC | 0 ± 0 c | 18 ± 6 de |
| 4% SCC | | 9 ± 14 e |
| 1% SS | 28 ± 3 b | 39 ± 3 cde |
| 2% SS | | |
| 3% SS | | |
| 4% SS | | |
| 1% SW | 47 ± 2 a | 61 ± 17 abcd |
| 2% SW | 4 ± 4 c | 85 ± 20 ab |
| 3% SW | | 50 ± 10 bcde |
| 5% SW | | 47 ± 3 bcde |

*Mean ± standard deviation, n = 3. Means within the same column followed by the same letter are not different by ANOVA followed by Tukeys HSD □ = 0.05.
**Represents the reanalyzed Table 12 data with the negative means removed.
STMB = SoyTech,
SW = SuperWet,
SC-1000, SCC = SC-1000 3X,
SS = SuperSolve.

SUPERSOLVE (SS). The increase in tomato growth was 28% and in pepper was 39% with the application of 1% concentration of SuperSolve. Higher concentrations, 2, 3, and 4% completely killed the plants. The symptoms were typical with the application of SuperSolve. The mother stem of the plants was green and standing. Leaves died first. That is, with Super Solve, plants died from the top down.

SC-1000 3× (SCC). The 3x concentrate of SC-1000 stopped tomato plant growth at 2, 3, and 4%. The 1% concentration of SCC was not different from the water control (Table 12). For pepper there was a dose effect on plant height with the lowest concentration, 1%, no different from the water control and the 2, 3, and 4% concentrations showing greater height reduction with increasing concentration.

SuperWet (SW). Tomato plants increased 47% in height with the application of 1% Super Wet Tomato height increase was only 4% with 2% SW with the 3 and 4% concentrations of Super Wet. In contrast, pepper height increased 47% with the 4% concentration of Super Wet. Pepper plants looked completely normal with the application of other concentrations of Super Wet and the percent increase in pepper plant growth ranged from 50 to 85% (Table 12).

Table 14 presents the mortality data for 7 days after the treatment. These data are important as they indicate that living plants might be treated for soil pests at between 1% and 2% concentrations of SuperWet, SC-1000, and SC-1000 3×.

General Observations. Table 13 is the reanalyzed data of Table 12 with the killed plants removed from the analysis. Table 13 data clearly illustrates that pepper is less sensitive to these treatments compared to tomato. The percent increase in plant height for tomato controls was 54% and 97% for pepper seedlings. No concentration of these products showed a greater percent increase in plant height than controls (Table 13). That is, there was no stimulation of the growth of tomato or pepper in 7 days. Perhaps monitoring plant growth for longer than 7 days would

TABLE 14
Mean percent mortality of tomato and pepper plants.

| | Water | | 4% | | 3% | | 2% | | 1% | |
|---|---|---|---|---|---|---|---|---|---|---|
| Treatments | Tomato | Pepper | Tomato | Pepper | Tomato | Pepper | Tomato | Pepper | Tomato | Pepper |
| STMB | 0 | 0 | 100 | 100 | 100 | 100 | 100 | 100 | 30 | 0 |
| SuperWet | 0 | 0 | 50 | 0 | 45 | 0 | 60 | 0 | 15 | 0 |
| SC-1000 | 0 | 0 | 25 | 0 | 15 | 0 | 15 | 0 | 0 | 0 |
| SC-1000 3x | 0 | 0 | 95 | 25 | 85 | 25 | 65 | 25 | 25 | 0 |
| SuperSolve | 0 | 0 | 100 | 100 | 100 | 100 | 75 | 100 | 20 | 25 |

show plant growth stimulation by these products.

### Example 15

Four experiments were carried out to determine the efficacy of certain agents in killing larvae (5th-9th instar) of the root weevil, Diaprepes abbreviatus (L.) and juvenile stages of the plant parasitic nematode Tylenchulus semipenetrans in laboratory assays.

Products were tested at 5% solutions in carbonated water. Solutions of SC-1000, SuperWet, SuperSolve, and STMB rendered Diaprepes abbreviatus moribund. Carbonated water and water controls remained active and displayed mortality from nipping behavior. SC-1000, Pel Soy 676, STMB, and ethoxylated castor oil (CAS# 61791-12-6) provided control of citrus nematode.

Diaprepes Abbreviatus: Experiment 1. Protocol: One larva was placed in a soil-filled cage and immersed in the test solution for 8 minutes. The cage consisted of a 225 mesh stainless steel in-line sprayer filter (7 cm length×3 cm diameter; Chemical Container, Lake Wales, Fla.). The cylindrical filter was capped on both ends using polyethylene snap caps (3.0 cm outside diameter). The time of immersion was arbitrary. Each cage was allowed to drain until drip-less and then held at 27° C. The larvae were removed from the cages and examined after 48 hours to determine their condition. Death was defined as no movement when jabbed with a blunt probe. The larvae were then held at 27° C. for a further 24 hours and their condition checked again.

Ten replications of each of the five treatments were conducted. One larva was defined as a replication. This represented a total of 50 larvae and 50 cages.

Treatments: A. SoyFast Manufacturers Base from Soy Technologies, LLC. (Nicholasville, Ky.); B. SC-1000 from Gemtek Products (Phoenix, Ariz.); C. SuperWet 7-057 from Anderson Chemical Co. (Litchfield, Minn.); D. carbonated water control; and E. distilled water control. Each product was tested as a 5% solution in carbonated water. Results are shown in Table 15.

TABLE 15
Experiment 1 (Mar. 23, 2007)

| | |
|---|---|
| 0 hours | 48 hours |

| Treatment | Alive | Dead | Alive | Dead |
|---|---|---|---|---|
| STMB | 5 | 5 | 6 | 4 |
| SC-1000 | 8 | 2 | 8 | 2 |
| SuperWet | 8 | 2 | 9 | 1 |

Controls

| | | | | |
|---|---|---|---|---|
| Carbonated water | 9 | 1 | 10 | 0 |
| Distilled water | 3 | 7 | 9 | 1 |

Experiment 2. Protocol: The testing protocol was the same as in Experiment 1 except that six treatments were used and the second check on the condition of the larvae was conducted after an additional 72 hours.

Treatments: A. SoyFast Manufacturers Base from Soy Technologies; B. SC-1000 from Gemtek Products; C. SuperWet 7-057 from Anderson Chemical Co.; D. SuperSolve from Gemtek Products; E. carbonated water control; and F. distilled water control. Each product was tested as a 5% solution in carbonated water. Results are shown in Table 16.

TABLE 16
Experiment 3.

| | |
|---|---|
| 0 hours | 48 hours |

| Treatment | Alive | Dead | Alive | Dead |
|---|---|---|---|---|
| STMB | 2 | 8 | 1 | 9 |
| SC-1000 | 6 | 4 | 4 | 9 |
| SuperWet | 3 | 7 | 1 | 9 |
| SuperSolve | 7 | 3 | 2 | 8 |

Controls

| | | | | |
|---|---|---|---|---|
| Carbonated water | 7 | 3 | 2 | 8 |
| Distilled water | 4 | 6 | 3 | 7 |

Experiment 3. Protocol: Ten larvae were placed in a plastic cylinder (5 cm diameter x 5 cm high) with a screened bottom and immersed in the test solution for 8 minutes. The time of immersion was arbitrary. Each cylinder was then immersed in distilled water several times for a few seconds and allowed to drain until drip-less. The larvae were then placed on filter paper in a plastic Petri dish and held at room temperature. The condition of the larvae was examined immediately (0 hours) and again after 48 hours. Death was defined as no movement when jabbed with a blunt probe. Ten replications of each of seven treatments were conducted. One larva was defined as a replication. This represented a total of 70 larvae and 7 cylinders.

Treatments: A. SoyFast Manufacturers Base from Soy Technologies; B. SC-1000; C. SC-1000 3x from Gemtek Products; D. SuperWet 7-057 from Anderson Chemical Co.; E. SuperSolve from Gemtek Products; F. carbonated water control; and G. distilled water control. Each product was tested as a 5% solution in carbonated water. Results are shown in Table 17.

TABLE 17
Experiment 3 (Nov. 9, 2007).

| | |
|---|---|
| 0 hours | 48 hours |

| Treatment | Alive | Dead | Alive | Dead |
|---|---|---|---|---|
| STMB | 10 | 0 | 9 | 1 |
| SC-1000 | 10 | 0 | 9 | 1 |
| SC-1000 3x | 10 | 0 | 6 | 4 |
| SuperWet | 10 | 0 | 9 | 1 |
| SuperSolve | 10 | 0 | 9 | 1 |

Controls

| | | | | |
|---|---|---|---|---|
| Carbonated water | 10 | 0 | 9 | 1 |
| Distilled water | 10 | 0 | 5 | 5 |

Conclusions. In the first experiment, SoyFast Manufacturers Base appeared to cause the greatest mortality (4 of 10 larvae died), but none of the other products appeared to be effective. Some instances of apparent mortality observed when the cages were initially opened after 48 hours were proven to be false when the larvae were again observed after 72 hours. This was especially apparent in the distilled water control. In the second experiment, considerable mortality was observed for all treatments but extensive mortality in the controls was also observed, and therefore mortality cannot be attributed to the treatments. Because of concerns that the small soil-filled cages in Experiments 1 and 2 were not draining effectively and therefore that the larvae were being exposed to the treatments for much longer periods than desired, the protocol was changed for Experiment 3 to assure proper draining and a rinsing step was included. In Experiment 3, immediately after immersion (0 hours), all larvae responded to the touch test and were deemed alive but larvae in the controls (carbonated water and distilled water) were observed to be extremely active whereas those receiving the other treatments were decidedly inactive. After 48 hours, none of the treatments appeared to induce mortality greater than that observed in the distilled water control but 4 of 10 larvae were dead in Treatment C (SafeCare SC-1000 3×). In this case, some of the mortality in the distilled water control might have been caused by the highly active larvae damaging one another.

Tylenchulus semipenetrans: Experiment 4. Protocol: On day 1, fifteen Styrofoam® coffee cups (7 cm diameter×9 cm depth) with perforated bottoms were filled to within 1 inch from the top with sandy soil naturally infested with Tylenchulus semipenetrans. Soil moisture was 4% prior to treatment. Three replicate cups were treated with one of five treatments (control and unknown compounds A, B, C, D). The control consisted of commercial carbonated water. The remaining treatments consisted of unknown compounds mixed with carbonated water to achieve solutions of 5% active ingredient. Fifty mL of each material were added to each cup. Cups were covered with Saranwrap®, placed into a plastic box lined with moist paper towels and incubated (28° C.) in the dark for 72 hours. On day 3, the contents of each cup were divided among two Baermann funnels. Nematodes that migrated from soil were recovered on day 6 and counted. Counts were transformed to log (X+1), subjected to ANOVA and means were separated using Tukey's Honestly Significant Difference Test.

Results:
Control (53.6±4.2; 62, 50, 49)
A. SC-1000: (0.33±0.33; 0, 0, 1)
B. Pel-Soy 676: (5.0±1.2; 7, 3, 5)
C. STMB: (0±0; 0, 0, 0)
D. 61791-12-6, castor, ethoxylated: (10.7±1.7; 14, 9, 9) (Mean ± standard error; raw data)

Nematodes in two replicates of treatment D were not moving in contrast to those in controls. We also noted that compound A moved more readily in soil and drained from the bottoms to a larger degree than controls or treatments C and D. Treatment B did not penetrate soil for at least 30 minutes (when it was placed in incubator).

All compounds reduced the recovery of motile nematodes.

### Remarks

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above compositions, products, and methods without departing from the scope of aspects of the invention, it is intended that all matter contained in the above description shall be interpreted as illustrative and not in a limiting sense.

While the foregoing description makes reference to particular illustrative embodiments, these examples should not be construed as limitations. The inventive system, methods, and devices can be adapted for many other uses not explicitly listed above, and can be modified in numerous ways within the spirit of the present disclosure. Thus, the present invention is not limited to the disclosed embodiments, but is to be accorded the widest scope consistent with the claims below.

We claim:

1. A method of reducing the population of one or more pests in soil comprising application of an aqueous solution of a bio-derived surfactant to the soil, the surfactant being derived by esterification of a naturally occurring lipid having a carbon number of 16 or higher, said bio-derived surfactant having an HLB value greater than about 6 and comprising a fatty alcohol derivative.

2. The method of claim 1, wherein the bio-derived surfactant further comprises the ester product of a naturally occurring lipid, said surfactant having an average carbon chain length greater than 14 and an HLB value greater than about 6.

3. The method of claim 1, wherein the bio-derived surfactant comprises at least one of a methoxylated vegetable oil and an ethoxylated vegetable oil, the ethoxylated vegetable oil having an HLB value greater than about 6 and an average degree of ethoxylation greater than 1, and wherein the concentration of the bio-derived surfactant in the aqueous solution is at least 0. 1%.

4. The method of claim 1, wherein the bio-derived surfactant comprises an ethoxylate of fatty alcohols obtained from soybean oil or castor oil with an average degree of ethoxylation greater than 1.

5. The method of claim 1, wherein the aqueous solution is substantially free of all chemical pesticides registered with the EPA as of Jul. 30, 2007, and wherein the aqueous solution is effective in substantially reducing the activity or population of harmful nematodes in the soil without the use of additional pesticidal agents.

6. The method of claim 1, wherein the aqueous solution is substantially free of all EPA-registered pesticides other than minimal risk pesticides, based on registration as of Jul. 30, 2007.

7. The method of claim 1, wherein the components of the aqueous solution other than water include 20 to 100 parts of a blend of polyethoxylated fatty acids and fatty alcohols with an average degree of ethoxylation greater than 10, and further comprise from 0 to 100 parts of a vegetable oil methyl ester; 0 to 100 parts vegetable oil; 0 to 10 parts pentanedioic acid, dimethyl ester; 0 to 10 parts butanedioic acid, dimethyl ester; 0 to 10 parts hexanedioic acid, dimethyl ester; 0 to 50 parts polyoxyethylene tridecyl ester; and 0 to 20 parts ethoxylated alkylaryl phosphate ester.

8. The method of claim 1, wherein the treatment produces two or more functions that effectively reduce the damage to a crop from at least two differing types of pests, the functions being selected from reducing the activity of insect larvae, reducing the activity of nematodes, and harming weeds by at least one of preventing germination, stunting the growth of existing weeds, or killing weeds.

9. The method of claim 1, wherein application of the aqueous solution comprises at least one of spraying, injection into the soil, drip irrigation, and flooding.

10. The method of claim 1, wherein application of the aqueous solution is done prior to planting an intended crop.

11. The method of claim 1, wherein the aqueous solution is carbonated.

12. The method of claim 1, further comprising delivering elevated concentrations of carbon dioxide into the soil as the aqueous solution is applied.

13. The method of claim 1, further comprising contacting the aqueous solution with an atmosphere of pressurized carbon dioxide prior to application of the aqueous solution to the soil sufficiently long to substantially elevate the levels of dissolved carbon dioxide in the aqueous solution.

14. The method of claim 1, further comprising combination of carbon dioxide with a portion of the aqueous solution, followed by application of the portion of the aqueous solution to the soil, such that the soil is provided with enhanced levels of carbon dioxide relative to ambient levels.

15. The method of claim 1, wherein application of the aqueous solution to the soil comprises one of irrigating the soil, injecting the solution into the soil, and spraying the soil, such that an effective concentration of the bio-derived surfactant is present in the soil at a depth of about 10 cm or greater one day after application is complete.

16. The method of claim 1, application of the aqueous solution to the soil substantially wets the soil at a depth of about 10 cm below the surface.

17. The method of claim 1, wherein the bio-derived surfactant is effective against one of insects that attack plant roots and harmful nematodes.

18. The method of claim 1, wherein the aqueous solution is a concentrate having less than 95% water present.

19. The method of claim 1, wherein the aqueous solution further comprises from about 0.1 to about 5% of an ethoxylated fatty alcohol.

20. The method of claim 1, wherein the aqueous solution further comprises from about 0.1 to about 5% of ethoxylated fatty alcohol having an average carbon number of 11 or greater and an average degree of ethoxylation greater than 1.

21. A method of controlling unwanted nematodes affecting a plant comprising application of an aqueous solution of a bio-derived surfactant to the plant or the soil around the plant, the surfactant being derived by epoxidation a fatty alcohol having a carbon number of 16 or higher, said bio-derived surfactant having an HLB value greater than about 6.

22. The method of claim 21, wherein the concentration of the bio-derived surfactant in the aqueous solution is from about 0.1% to about 5%.

23. The method of claim 21, wherein the aqueous solution is substantially free of conventional chemical pesticides.

24. The method of claim 21, wherein the bio-derived surfactant has an HLB value greater than about 9.

25. The method of claim 21, wherein the bio-derived surfactant has an HLB value greater than about 11.

26. The method of claim 21, wherein the aqueous solution further comprises from about 0.1 to about 5% of ethoxylated fatty alcohol having an average carbon number of 13 or greater and an average degree of ethoxylation greater than 1.

27. A method of treating the soil around a living plant to protect the plant from harmful pests, comprising preparing an aqueous solution of from about 0.05 to 5% of a bio-derived surfactant, said surfactant being derived from a naturally occurring lipid, and applying the solution to the soil in contact with the roots of the plants, wherein the aqueous solution is substantially free of any chemical pesticide registered with the EPA as of Sept. 1, 2007.

28. The method of claim 27, wherein the surfactant comprises derivatives of naturally occurring fatty acids or fatty alcohols having a carbon number greater than 14.

29. The method of claim 27, wherein the surfactant comprises derivatives of naturally occurring fatty acids, said derivatives having an HLB value of about 9 or greater.

30. The method of claim 27, wherein the surfactant comprises an ethoxylated fatty alcohol obtained from a naturally occurring lipid, said surfactant having an average degree of ethoxylation greater than 1.

31. A method of treating soil to control two or more classes of organisms that are antagonistic to a crop, comprising applying an effective amount of an aqueous solution to the soil where the crop is to be grown, the aqueous solution comprising from about 0.05 to 5% of a bio-derived surfactant, wherein the surfactant comprises an ethoxylated fatty alcohol derived from one or more vegetable lipids, and wherein the surfactant has an HLB value of about 7 or greater and an average carbon chain length greater than 14.

32. The method of claim 31, wherein the bio-derived surfactant further comprises a fatty acid ester derived from a naturally occurring lipid.

33. The method of claim 32, wherein the bio-derived surfactant comprises a fatty acid ester formed by ethoxylation of the naturally occurring lipid or a fatty acid obtained from the naturally occurring lipid, said surfactant having an average degree of ethoxylation greater than 1.

34. The method of claim 31 or 32, wherein the bio-derived surfactant comprises a fatty acid alcohol derivative having a characteristic carbon chain length of from about 16 to 18.

35. The method of claim 32, wherein the bio-derived surfactant has an HLB value of about 9 or greater.

36. A method of reducing the population of one or more pests that attack the roots of plants comprising application of an aqueous solution of a surfactant to the soil, the surfactant being derived by esterification of a fatty acid or fatty alcohol having a carbon number of 16 or higher, said surfactant having an HLB value greater than about 6.

37. The method of claim 36, wherein the one or more pests comprise nematodes.

38. The method of claim 36, wherein the one or more pests comprises insects.

39. The method of claim 38, wherein the insects comprise insect larvae.

40. The method of claim 38, wherein the insects comprise adult insects.

41. The method of claim 36, wherein the one or more pests comprise weeds.
